(19) United States
(12) Patent Application Publication
(10) Pub. No.: US 2003/0060575 A1
(43) Pub. Date: Mar. 27, 2003

(54) Polycarbonates suitable for use in optical articles

(76) Inventors: Andrew James Caruso, Schenectady, NY (US); Gary Charles Davis, Albany, NY (US); Jan-Pleun Lens, Breda (NL); Hans Peter Brack, Herrliberg (CH); Marc Brian Wisnudel, Clifton Park, NY (US); Kathryn Lynn Longley, Saratoga Springs, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/905,366

(22) Filed: Jul. 16, 2001

(51) Int. Cl. C08F 283/02

(52) U.S. Cl. 525/462

(57) ABSTRACT

This invention provides certain polycarbonates and polycarbonate blends useful in optical article applications. In a preferred embodiment, copolymers of, for example, certain ortho substituted bisphenol A-based polycarbonates and bisphenol A, optionally further comprising polycarbonate residues derived from ortho subsitituted spirobiindane compounds and alkylene or cycloalkylene diacid moieties. In a further embodiment, the invention provides copolymers of certain ortho-substituted bisphenol A moieties and ortho-substituted spirobiindane moieties. Also provided are optical articles comprised of the copolymers and blends of the invention. We have found that such copolymers and blends exhibit superior dimensional stability when exposed to water or moisture.

### BACKGROUND OF THE INVENTION

This invention relates to polycarbonates suitable for use in optical articles, and methods for making such polycarbonates. This invention further relates to optical articles, and methods for making optical articles from the polycarbonates.

Polycarbonates and other polymer materials are utilized in optical data storage media, such as compact disks. In optical data storage media, it is critical that polycarbonate resins have good performance characteristics such as transparency, low water affinity, good processibility, good heat resistance and low birefringence. High water affinity is particularly undesirable in high density optical data storage media as it results in warpage of the recording layer and poor data fidelity

Improvements in optical data storage media, including increased data storage density, are highly desirable, and achievement of such improvements is expected to improve well established and new computer technology such as read only, write once, rewritable, digital versatile and magneto-optical (MO) disks.

In the case of CD-ROM technology, the information to be read is imprinted directly into a moldable, transparent plastic material, such as bisphenol A (BPA) polycarbonate. The information is stored in the form of shallow pits embossed in a polymer surface. The surface is coated with a reflective metallic film, and the digital information, represented by the position and length of the pits, is read optically with a focused low power (5 mW) laser beam. The user can only extract information (digital data) from the disk without changing or adding any data. Thus, it is possible to “read” but not to “write” or “erase” information.

The operating principle in a WORM drive is to use a focused laser beam (20-40 mW) to make a permanent mark on a thin film on a disk. The information is then read out as a change in the optical properties of the disk, e.g., reflectivity or absorbance. These changes can take various forms: “hole burning” is the removal of material, typically a thin film of tellurium, by evaporation, melting or spalling (sometimes referred to as laser ablation); bubble or pit formation involves deformation of the surface, usually of a polymer overcoat of a metal reflector.

Although the CD-ROM and WORM formats have been successfully developed and are well suited for particular applications, the computer industry is focusing on erasable media for optical storage (EODs). There are two types of EODs: phase change (PC) and magneto-optic (MO). In MO storage, a bit of information is stored as a ˜1 μm diameter magnetic domain, which has its magnetization either up or down. The information can be read by monitoring the rotation of the plane polarization of light reflected from the surface of the magnetic film. This rotation, called the Magneto-Optic Kerr Effect (MOKE) is typically less than 0.5 degrees. The materials for MO storage are generally amorphous alloys of the rare earth and transition metals.

Amorphous materials have a distinct advantage in MO storage as they do not suffer from “grain noise”, spurious variations in the plane of polarization of reflected light caused by randomness in the orientation of grains in a polycrystalline film. Bits are written by heating above the Curie point, T_{c}, and cooling in the presence of a magnetic field, a process known as thermomagnetic writing. In the phase-change material, information is stored in regions that are different phases, typically amorphous and crystalline. These films are usually alloys or compounds of tellurium which can be quenched into the amorphous state by melting and rapidly cooling. The film is initially crystallized by heating it above the crystallization temperature. In most of these materials, the crystallization temperature is close to the glass transition temperature. When the film is heated with a short, high power focused laser pulse, the film can be melted and quenched to the amorphous state. The amorphized spot can represent a digital “1” or a bit of information. The information is read by scanning it with the same laser, set at a lower power, and monitoring the reflectivity.

In the case of WORM and EOD technology, the recording layer is separated from the environment by a transparent, non-interfering shielding layer. Materials selected for such “read through” optical data storage applications must have outstanding physical properties, such as moldability, ductility, a level of robustness compatible with popular use, resistance to deformation when exposed to high heat or high humidity, either alone or in combination. The materials should also interfere minimally with the passage of laser light through the medium when information is being retrieved from or added to the storage device.

As data storage densities are increased in optical data storage media to accommodate newer technologies, such as digital versatile disks (DVD), recordable and rewritable digital versatile disks (DVD-R and DVD-RW), high density digital versatile disks (HD-DVD), digital video recorders (DVR), and higher density data disks for short or long term data archives, the design requirements for the transparent plastic component of the optical data storage devices have become increasingly stringent. In many of these applications, previously employed polycarbonate materials, such as BPA polycarbonate materials, are inadequate. Materials displaying lower birefringence at current, and in the future progressively shorter “reading and writing” wavelengths have been the object of intense efforts in the field of optical data storage devices.

Low birefringence alone will not satisfy all of the design requirements for the use of a material in optical data storage media; high transparency, heat resistance, low water absorption, ductility, high purity and few inhomogeneities or particulates are also required. Currently employed materials are found to be lacking in one or more of these characteristics, and new materials are required in order to achieve higher data storage densities in optical data storage media. In addition, new materials possessing improved optical properties are anticipated to be of general utility in the production of other optical articles, such as lenses, gratings, beam splitters and the like.

Birefringence in an article molded from polymeric material is related to orientation and deformation of its constituent polymer chains. Birefringence has several sources, including the structure and physical properties of the polymer material, the degree of molecular orientation in the polymer material and thermal stresses in the processed polymer material. For example, the birefringence of a molded optical article is determined, in part, by the molecular structure of its constituent polymer and the processing conditions, such as the forces applied during mold filling and cooling, used in its fabrication which can create thermal stresses and orientation of the polymer chains.

The observed birefringence of a disk is therefore determined by the molecular structure, which determines the intrinsic birefringence, and the processing conditions, which can create thermal stresses and orientation of the polymer chains. Specifically, the observed birefringence is typically a function of the intrinsic birefringence and the birefringence introduced upon molding articles, such as optical disks. The observed birefringence of an optical disk is typically quantified using a measurement termed “vertical birefringence” or VBR, which is described more fully below.

Two useful gauges of the suitability of a material for use as a molded optical article, such as a molded optical data storage disk, are the material's stress optical coefficient in the melt (Cₘ) and its stress optical coefficient in the glassy state (C_{g}), respectively. The relationship between Cₘ, C_{g} and birefringence may be expressed as follows:

Δn=Cₘ×Δσₘ (1)

Δn=C_{g}×Δσ_{g} (2)

where Δn is the measured birefringence and Δσₘ and Δσ_{g} are the applied stresses in the melt and glassy states, respectively. The stress optical coefficients Cₘ and C_{g} are a measure of the susceptibility of a material to birefringence induced as a result of orientation and deformation occurring during mold filling and stresses generated as the molded article cools.

The stress optical coefficients Cₘ and C_{g} are useful as general material screening tools and may also be used to predict the vertical birefringence (VBR) of a molded article, a quantity critical to the successful use of a given material in a molded optical article. For a molded optical disk, the VBR is defined as:

VBR=(nᵣ−n_{z})=Δn_{rz} (3)

where nᵣ and n_{z} are the refractive indices along the r an z cylindrical axes of the disk; nᵣ is the index of refraction seen by a light beam polarized along the radial direction, and n_{z} is the index of refraction for light polarized perpendicular to the plane of the disk. The VBR governs the defocusing margin, and reduction of VBR will lead to alleviation of problems which are not correctable mechanically.

In the search for improved materials for use in optical articles, Cₘ and C_{g} are especially useful since they require minimal amounts of material and are relatively insensitive to uncontrolled measurement parameters or sample preparation methods, whereas measurement of VBR requires significantly larger amounts of material and is dependent upon the molding conditions. In general, it has been found that materials possessing low values of C_{g} and Cₘ show enhanced performance characteristics, for example VBR, in optical data storage applications relative to materials having higher values of C_{g} and Cₘ. Therefore, in efforts aimed at developing improved optical quality, widespread use of C_{g} and Cₘ measurements is made in order to rank potential candidates for such applications and to compare them with previously discovered materials.

In applications requiring higher storage density, the properties of low birefringence and low water absorption in the polymer material from which the optical article is fabricated become even more critical. In order to achieve higher data storage density, low birefringence is necessary so as to minimally interfere with the laser beam as it passes through the optical article, for example a compact disk.

Another critical property needed for high data storage density applications is disk flatness. It is known that excessive moisture absorption results in disk skewing which in turn leads to reduced reliability. Since the bulk of the disk is comprised of the polymer material, the flatness of the disk depends on the low water absorption of the polymeric material. In order to produce high quality disks through injection molding, the polymer, such as polycarbonate should be easily processed.

There exists a need for compositions having good optical properties and good processibility and which are suitable for use in high density optical recording media. Polycarbonates manufactured by copolymerizing aromatic dihydroxy compounds, such as bisphenol A, with other monomers, such as SBI, may produce acceptable birefringence; however the glass transition temperature is often too high, resulting in poor processing characteristics. Consequently, the obtained moldings have low impact resistance. Further, the water absorption of such polycarbonates is unacceptable for higher density applications.

### BRIEF SUMMARY OF THE INVENTION

The present invention solves these problems, and provides compositions for storage media having unexpected and advantageous properties. These and further objects of the present invention will be more readily appreciated by considering the following disclosure and appended claims.

The present invention, in one aspect, relates to the blending of polymers to produce miscible blend compositions. In a further aspect, the applicants were surprised to discover that the miscible blend compositions of the present invention possess suitable properties for use in optical articles, in particular for use in optical data storage media.

This invention provides certain polycarbonates and polycarbonate blends useful in optical article applications. In a preferred embodiment, the present invention provides copolymers of, for example, certain ortho substituted bisphenol A-based polycarbonates and bisphenol A, optionally further comprising polycarbonate residues derived from ortho subsitituted spirobiindane compounds and alkylene or cycloalkylene diacid moieties. In a further embodiment, the present invention provides copolymers of certain ortho-substituted bisphenol A moieties and ortho-substituted spirobiindane moieties. Also provided are optical articles comprised of the copolymers and blends of the present invention. We have found that such copolymers and blends exhibit superior dimensional stability when exposed to water or moisture.

### BRIEF DESCRIPTION OF THE DRAWINGS

FIG. 1 is a functional bar graph illustrating the effect of substitution on water uptake of polycarbonates.

FIG. 2 is a plot illustrating water absorption in BCC:BPA copolymers.

FIG. 3 is a plot illustrating radial deviation versus aging time.

FIG. 4 is a plot illustrating radial deviation normalized by subtracting initial radial deviation.

FIG. 5 is a plot illustrating vertical deviation at outer radius (normalized by initial deviation).

FIG. 6 is a plot illustrating the performance of BCC and BCC-BPA PCs relative to BPA-PC vertical deviation at outer radius (normalized by initial deviation).

FIG. 7 is a plot illustrating the nonlinear dependence of water diffusivity on percent of BCC in BCC/BPA-PC blends.

FIG. 8 is a plot illustrating water uptake in BCC/BPA-PC blends indicating initial slow diffusion of water into CDs.

FIG. 9 is a plot illustrating dimensional stability of CDs from BCC-PC/Lexan blends.

FIG. 10 is a plot illustrating a correlation of maximum change in vertical deviation to percent of BCC in the blend.

FIG. 11 is a plot illustrating a correlation of maximum change in vertical deviation to percent equilibrium water uptake.

### DETAILED DESCRIPTION OF THE INVENTION

The present invention may be understood more readily by reference to the following detailed description of preferred embodiments of the invention and the Examples included therein.

Before the present compositions of matter and methods are disclosed, it is to be understood that this invention is not limited to specific synthetic methods or to particular formulations, as such may, of course, vary. It is also to be understood that the terminology used herein is for the purpose of describing particular embodiments only and is not intended to be limiting.

In this specification and in the claims which follow, reference will be made to a number of terms which shall be defined to have the following meanings.

The singular forms “a,” “an” and “the” include plural referents unless the context clearly dictates otherwise.

“Optional” or “optionally” means that the subsequently described event or circumstances may or may not occur, and that description includes instances where the event or circumstance occurs and instances where it does not.

“BPA” is herein defined as bisphenol A or 2,2-bis(4-hydroxyphenyl)propane.

“SBI” is herein defined as 6,6′-dihydroxy-3,3,3′,3′-tetramethylspirobiindane.

“BCC” is herein defined as 1,1-bis(4-hydroxy-3-methyl phenyl) cyclohexane.

“CD-1” is herein defined as 6-hydroxy-1-(4′-hydroxyphenyl)-1,3,3-trimethylindane.

“BPM” is herein defined as 4,4′-(1,3-phenylenediisopropylidene)bisphenol.

“BPZ” is herein defined as 1,1-bis(4-hydroxyphenyl)cyclohexane.

“BPI” is herein defined as 1,1-bis(4-hydroxyphenyl)3,3,5-trimethylcyclohexane.

“bisAP” is herein defined as 4,4′-(1-phenylethylidene)bisphenol.

“C_{g}” is the stress optical coefficient of a polymeric material in the glassy state, measured in Brewsters (10⁻¹³ cm²/dyne).

“Cₘ” is the stress optical coefficient in the melt phase, measured in Brewsters (10⁻¹³ cm²/dyne).

“TMBPA” is 2,2-bis(4-hydroxy-3,5-dimethyl)propane.

“DMBPA” is 2,2-bis(4-hydroxy-3-methyl)propane.

“MTBA” is methyltributylammonium chloride

“DCHBPA” is 2,2-bis(4-hydroxy-3-cyclohexylphenyl)propane

“Polycarbonate” or “polycarbonates” as used herein includes copolycarbonates, homopolycarbonates and (co)polyester carbonates.

“Optical articles” as used herein includes optical disks and optical data storage media, for example a compact disk (CD audio or CD-ROM), a digital versatile disk, also known as DVD (ROM,RAM, rewritable), a recordable digital versatile disk (DVD-R), a digital video recording (DVR), a magneto optical (MO) disk and the like; optical lenses, such as contact lenses, lenses for glasses, lenses for telescopes, and prisms; optical fibers; information recording media; information transferring media; high density data storage media, disks for video cameras, disks for still cameras and the like; as well as the substrate onto which optical recording material is applied. In addition to use as a material to prepare optical articles, the polycarbonate may be used as a raw material for films or sheets.

Unless otherwise stated, “mol %” in reference to the composition of a polycarbonate in this specification is based upon 100 mol % of the repeating units of the polycarbonate. For instance, “a polycarbonate comprising 90 mol % of BCC” refers to a polycarbonate in which 90 mol % of the repeating units are residues derived from BCC diphenol or its corresponding derivative(s). Corresponding derivatives include but are not limited to, corresponding oligomers of the diphenols; corresponding esters of the diphenol and their oligomers; and the corresponding chloroformates of the diphenol and their oligomers.

The terms “residues” and “structural units”, used in reference to the constituents of the polycarbonate, are synonymous throughout the specification.

In a first aspect, the present invention provides a polycarbonate comprising

(a) about 99.9 to 0.1 mole percent of carbonate structural units corresponding to

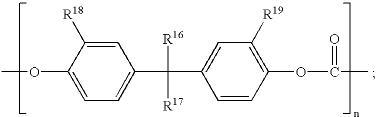

wherein R¹⁶ and R¹⁷ are independently selected from hydrogen, C₁-C₁₂ alkyl, or phenyl, or R¹⁶ and R¹⁷ are taken together to form a C₃-C₁₂ cycloalkyl; R¹⁸ and R¹⁹ and are independently selected from C₁-C₆ alkyl, C₃-C₆ cycloalkyl, or phenyl

(b) about 0.1 to 99.9 mole percent of carbonate structural units corresponding to

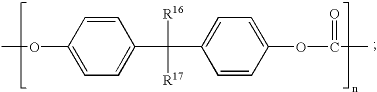

and optionally

(c) further comprising one or more carbonate structural units corresponding to units selected from the group consisting of

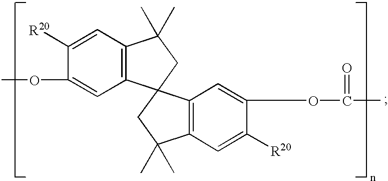

wherein each R²⁰ is independently selected from a group consisting of a hydrogen, C₁-C₆ alkyl, C₃-C₆ cycloalkyl, or phenyl; and

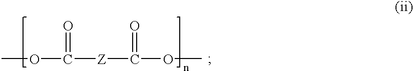

wherein Z is a C₁-C₄₀ branched or straight chain alkyl group or a C₃-C₈ cycloalkyl group, and n denotes the number of said structural units;

wherein the polycarbonate has a glass transition temperature of from about 100° C. to about 185° C. and a water absorption of below about 0.33%, the total of (a), (b), and (c) being 100 mole percent.

In the above polycarbonates, it is preferred that the glass transition temperature be from about 120° C. to about 165° C., more preferably from about 130° C. to about 150° C.

In this aspect of the present invention, it is further preferred in component (a), that R¹⁸ and R¹⁹ be selected from methyl, phenyl, n-butyl, sec-butyl, t-butyl, ethyl, cyclohexyl, and isopropyl.

It is further preferred that R²⁰ be selected from, methyl, ethyl, and hydrogen.

Preferred groups -Z- include groups of the formula.

—CH₂—CH₂—CH₂—CH₂—;

—CH₂—CH₂—CH₂—CH₂—CH₂—CH₂—;

—CH₂—CH₂—CH₂—CH₂—CH₂—CH₂—CH₂—CH₂—; and

—CH₂—CH₂—CH₂—CH₂—CH₂—CH₂—CH₂—CH₂—CH₂—CH₂— and the like.

In a further preferred embodiment, polycarbonate units (a), (b), and (c) (i) are present in proportions of 20 to 50:20 to 50: and 30 to 50 mole percent, respectively.

In a further preferred embodiment, polycarbonate units (a), (b), and (c) (ii) are present in proportions of 20 to 50:20 to 50: and 1 to 15 mole percent, respectively.

In a further preferred embodiment, polycarbonate units (a), (b), (c) (i), and (c) (ii), are present in proportions of 20 to 50:20 to 50:20 to 50 and :1 to 20 mole percent, respectively.

In each of the above preferred embodiments, it will be understood that the above proportions such that the total will always equal 100 mole percent.

In a second aspect, the present invention provides a polycarbonate comprising:

(a) about 0.1 to 99.1 mole percent of carbonate structural units corresponding to

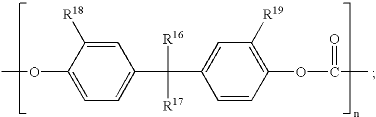

wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸ and R¹⁹ and are independently selected from C₁-C₆ alkyl, C₃-C₈ cycloalkyl, or phenyl

(b) about 99.1 to 0.1 mole percent of structural units corresponding to

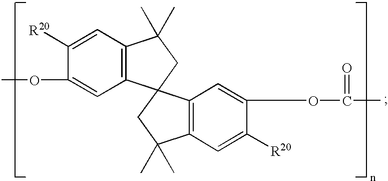

wherein each R²⁰ is independently selected from a group consisting of a C₁-C₆ alkyl, C₃-C₆ cycloalkyl, or phenyl;

wherein the polycarbonate has a glass transition temperature of from about 120° C. to about 185° C. and a water absorption of below about 0.33%.

In this aspect of the present invention, it is further preferred in component (a), that R¹⁸ and R¹⁹ be selected from methyl, ethyl, isopropyl, sec-butyl, tert-butyl and R¹⁸/R¹⁹ in cyclohexyl ring.

It is further preferred that R¹⁶ and R¹⁷ be selected from methyl, ethyl, and propyl.

It is further preferred that R²⁰ be selected from ethyl and methyl.

In this aspect, it is further preferred that structural units (a) are present in a range of 35 to 65 mole percent, most preferably about 45 to 55 mole percent, and structural units (b) are present in a range of 65 to 35 mole percent, most preferably about 55 to 45 mole percent.

In a further embodiment of this second aspect, the polycarbonate may be further comprised of up to about 50 mole percent of residues of bisphenol A.

The polycarbonates and blends of the present invention are useful in the manufacture of optical articles. Accordingly, in a third aspect, the present invention provides an optical article comprising

(I) from 90 to 99.99 percent by weight of a polycarbonate comprising

(a) about 99.9 to 0.1 mole percent of carbonate structural units corresponding to

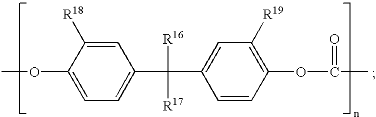

wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸, and R¹⁹ and are independently selected from C₁-C₆ alkyl, C₃-C₈ cycloalkyl, or phenyl

(b) about 0.1 to 99.9 mole percent of carbonate structural units corresponding to

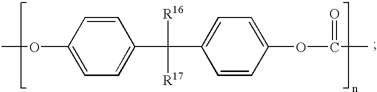

and optionally

(c) further comprising one or more carbonate structural units corresponding to units selected from the group consisting of

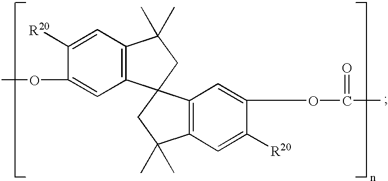

wherein each R²⁰ is independently selected from a group consisting of a C₁-C₆ alkyl, C₃-C₆ cycloalkyl, or phenyl; and

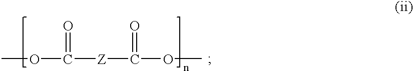

wherein Z is a C₁-C₄₀ branched or straight chain alkyl group or a C₃-C₈ cycloalkyl group group, and n denotes the number of said structural units;

wherein the polycarbonate blend has a glass transition temperature of from about 120° C. to about 185° C. and a water absorption of below about 0.33%; the total of (a), (b), and (c) being 100 mole percent, and

(II) from 0.01 to 10 weight percent of further additives.

Preferred R²⁰ groups include methyl, ethyl, n-propyl, isopropyl, n-butyl, sec-butyl, and t-butyl.

Preferred groups -Z- include groups of the formula.

—CH₂—CH₂—CH₂—CH₂—CH₂—CH₂—CH₂—CH₂—;

—C₂—CH₂—CH₂—CH₂—CH₂—C₂—CH₂—CH₂—CH₂—;

—CH₂—CH₂—CH₂—CH₂—CH₂—CH₂—CH₂—CH₂—CH₂—CH₂—; and

—CH₂—CH₂—CH₂—CH₂—CH₂—CH₂—CH₂—CH₂—CH₂—CH₂—CH₂— and the like.

Similarly, in a fourth aspect, the present invention provides an optical article comprising

(I) from 90 to 99.99 percent by weight of a polycarbonate comprising:

(a) about 0.1 to 99.9 mole percent of carbonate structural units corresponding to

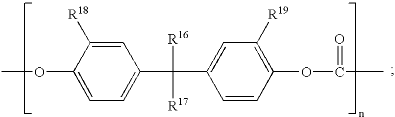

wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸, and R¹⁹ and are independently selected from C₁-C₆ alkyl, or phenyl

(b) about 99.1 to 0.1 mole percent of structural units corresponding to

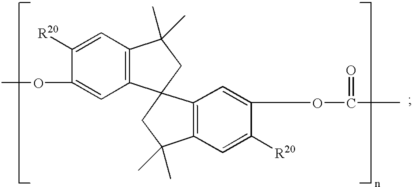

wherein each R²⁰ is independently selected from a group consisting of a C₁-C₆ alkyl, C₃-C₆ cycloalkyl, or phenyl;

wherein the polycarbonate has a glass transition temperature of from about 120° C. to about 185° C. and a water absorption of below about 0.33%; and

(II) from 0.01 to 10 weight percent of further additives.

We have also discovered that certain polycarbonates form miscible blends which are useful in optical recording applications. Thus, in a fifth aspect, the present invention provides a miscible polycarbonate blend comprising:

(A) a polycarbonate comprising structural units corresponding to

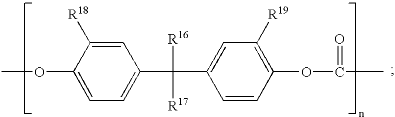

wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸, and R¹⁹ and are independently selected from C₁-C₆ alkyl, C₃-C₈ cycloalkyl, or phenyl;

(B) a polycarbonate comprising structural units corresponding to

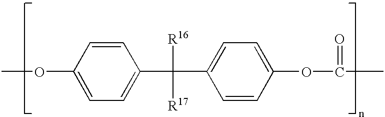

wherein R¹⁶ and R¹⁷ are independently selected from C₁-C₆ alkyl.

As noted in the fifth aspect, the miscible blends described therein are useful as optical articles. Accordingly, in a sixth aspect, the present invention provides an optical article comprising

(I) from 90 to 99.99 percent by weight of a miscible polycarbonate blend comprising

(A) a polycarbonate comprising structural units corresponding to

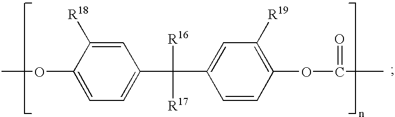

wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸, and R¹⁹ and are independently selected from C₁-C₆ alkyl, C₃-C₈ cycloalkyl, or phenyl

(B) a polycarbonate comprising structural units corresponding to

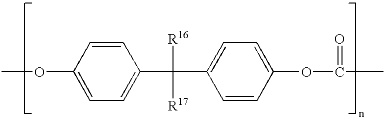

wherein R¹⁶ and R¹⁷ are independently selected from C₁-C₆ alkyl;

wherein the polycarbonate has a glass transition temperature of from about 120° C. to about 185° C. and a water absorption of below about 0.33%; and

(II) from 0.01 to 10 weight percent of further additives.

Especially preferred blends include those wherein dimethyl bisphenol A polycarbonate and bisphenol A polycarbonate are blended in a proportion of about 25-75 weight percent: 75-25 weight percent, respectively.

Especially preferred blends include those wherein BCC polycarbonate and bisphenol A polycarbonate are blended in a proportion of about 25-75 weight percent: 75-25 weight percent, respectively.

In the present invention it is further desirable that the polycarbonates possess other suitable properties for use in optical media. The polycarbonates of the present invention preferably have glass transition temperatures in the range of from about 120° C. to about 185° C., more preferably from about 125° C. to about 165° C., even more preferably from about 130° C. to about 150° C. The water absorption of the polycarbonates is preferably below 0.33%, even more preferably less than about 0.25%.

The weight average molecular weight (M_{W}), as determined by gel permeation chromotagraphy relative to polystyrene, of the polycarbonates is preferably from about 10,000 to about 100,000, more preferably between about 10,000 to about 50,000, even more preferably between about 25,000 to about 40,000.

The polycarbonate should have light transmittance of at least about 85%, more preferably at least about 90% and a C_{g} of less than about 60 Brewsters, more preferably less than 55 Brewsters, even more preferably less than 50 Brewsters. The polycarbonate preferably has a Cₘ of below about 3,000 Brewsters, more preferably below about 2,500 Brewsters, even more preferably less than about 2,450 Brewsters.

The compositions of a particular polycarbonate may be varied within certain ranges to achieve the suitable property profile. The ranges set forth herein are illustrative ranges for the desired embodiments.

The polycarbonates of the invention may be prepared by the interfacial, melt, or solid state processes. If the interfacial process is used, the addition of various phase transfer catalysts is optional. Phase transfer catalysts which are suitable include, but are not limited to tertiary amines, such as triethylamine; ammonium salts, such as tetrabutylammonium bromide; or hexaethylguanidium chloride. Monofunctional phenols, such as p-cumylphenol and 4-butylphenol; long chain alkylphenols, such as cardanol and nonyl phenol; and difunctional phenols may be used as chain stopping agents. Optionally 0.1 to 10 mole %, more preferably 1 to 5 mole % of chainstopping agent may be incorporated into the polycarbonate, based on the total moles of the repeating units.

In some instances, the phosgenation conditions must be adjusted. In particular, the phosgenation conditions should be adjusted in cases where the formation of undesired cyclic oligomers is favored by the characteristic reactivity of the monomer, which is related to monomer solubility in the reaction medium and monomer structure. In the case of BCC, for example, cyclic oligomer formation occurs to a greater extent under standard interfacial polymerization conditions than in the case of, for example, BPA. In polycarbonates containing substantially more than about 20 mol % of BCC, it is advantageous to use an excess of phosgene to promote the formation of linear bischloroformate oligomers which are converted to high molecular weight polymers by partial hydrolysis and polycondensation. Preferably from about 20 to 200 mol % of excess phosgene is used.

The polycarbonates of the present invention may also be prepared by the melt or transesterification process. This process does not require the use of phosgene or a solvent and minimizes the formation of low molecular weight contaminants, such as cyclic and linear low molecular weight oligomers in the final polymer. The monomers are mixed with a carbonate source, such as a diarylcarbonate, and a small amount of catalyst, such as an alkali metal hydroxide or ammonium hydroxide and heated under a vacuum according to a protocol in which the temperature is raised through a series of stages while the pressure in the headspace over the reaction mixture is lowered from ambient pressure to about 1 torr.

Suitable carbonate sources, catalysts and reaction conditions are found in U.S. Pat. No. 5,880,248, and Kirk-Othmer Encyclopedia of Chemical Technology, Fourth Edition, Volume 19, pp. 585-600, herein incorporated by reference. The time of the stages and the temperature are such that mechanical losses of material through foaming and the like are avoided. Phenol and excess diphenyl carbonate are removed overhead to complete the polymerization process. The product high polymer is then isolated as a melt which may be compounded with other additives, such as stabilizers and mold release agents prior to pelletization. The products produced by the melt process have reduced numbers of undissolved particles and reduced content of low molecular weight contaminants, such as cyclic oligomers, relative to the interfacially produced product.

The polycarbonates of the present invention may optionally be blended with any conventional additives used in optical applications, including but not limited to dyestuffs, UV stabilizers, antioxidants, heat stabilizers, and mold release agents, to form an optical article. In particular, it is preferable to form a blend of the polycarbonate and additives which aid in processing the blend to form the desired optical article. The blend may optionally comprise from 0.0001 to 10% by weight of the desired additives, more preferably from 0.0001 to 1.0% by weight of the desired additives.

Substances or additives which may be added to the polycarbonates of this invention, include, but are not limited to, heat-resistant stabilizer, UV absorber, mold-release agent, antistatic agent, slip agent, antiblocking agent, lubricant, anticlouding agent, coloring agent, natural oil, synthetic oil, wax, organic filler, inorganic filler and mixtures thereof.

Examples of the aforementioned heat-resistant stabilizers, include, but are not limited to, phenol stabilizers, organic thioether stabilizers, organic phosphite stabilizers, hindered amine stabilizers, epoxy stabilizers and mixtures thereof. The heat-resistant stabilizer may be added in the form of a solid or liquid.

Examples of UV absorbers include, but are not limited to, salicylic acid UV absorbers, benzophenone UV absorbers, benzotriazole UV absorbers, cyanoacrylate UV absorbers and mixtures thereof.

Examples of the mold-release agents include, but are not limited to natural and synthetic paraffins, polyethylene waxes, fluorocarbons, and other hydrocarbon mold-release agents; stearic acid, hydroxystearic acid, and other higher fatty acids, hydroxyfatty acids, and other fatty acid mold-release agents; stearic acid amide, ethylenebisstearoamide, and other fatty acid amides, alkylenebisfatty acid amides, and other fatty acid amide mold-release agents; stearyl alcohol, cetyl alcohol, and other aliphatic alcohols, polyhydric alcohols, polyglycols, polyglycerols and other alcoholic mold release agents; butyl stearate, pentaerythritol tetrastearate, and other lower alcohol esters of fatty acid, polyhydric alcohol esters of fatty acid, polyglycol esters of fatty acid, and other fatty acid ester mold release agents; silicone oil and other silicone mold release agents, and mixtures of any of the aforementioned.

The coloring agent may be either pigments or dyes. Inorganic coloring agents and organic coloring agents may be used separately or in combination in the present invention. Insofar as one desired utility for the polycarbonates and polycarbonate blends of this case is in optical articles, it is most preferred that the polycarbonates and polycarbonate blends be transparent.

The polycarbonates may be random copolymers, block copolymers or graft copolymers. When graft copolymers and other branched polymers are prepared a suitable branching agent is used during production.

The desired optical article may be obtained by molding the polycarbonate or polycarbonate blend by injection molding, compression molding, extrusion methods and solution casting methods. Injection molding is the more preferred method of forming the article.

Because the polycarbonates of the present invention possess advantageous properties such as low water absorption, good processibility and low birefringence, they can be advantageously utilized to produce optical articles. End-use applications for the optical article of the invention include, but are not limited to, a compact disk, a digital audio disk, a digital versatile disk, an magneto-optical disk, an ASMO device and the like; optical lenses, such as contact lenses, lenses for glasses, lenses for telescopes, and prisms; optical fibers; photonics devices such as waveguides and the like; information recording media; information transferring media; disks for video cameras, disks for still cameras and the like.

The polycarbonate may function as the medium for data storage, i.e. the data may be fixed onto or into the polycarbonate. The polycarbonate may also function as the substrate onto which a data storage medium is applied. An example being a plastic substrate for a first-surface data storage format such as a DVR disk and the like. Further, some combination of both functions may be employed in a single device, as for instance when the polycarbonate is imprinted with tracking to aid in reading a data storage medium which is applied to the polycarbonate.

In the present invention it is further critical that the polycarbonates possess suitable properties for use in optical articles. The polycarbonates of the further aspect of the present invention preferably have glass transition temperatures in the range of from about 120° C. to about 185° C., more preferably from about 125° C. to about 165° C., even more preferably from about 130° C. to about 150° C. The water absorption of the polycarbonates is preferably below about 0.33%, even more preferably less than about 0.20%.

The weight average molecular weight (M_{W}), as determined by gel permeation chromotagraphy relative to polystyrene, of the polycarbonates is preferably from about 10,000 to about 100,000, more preferably between about 10,000 to about 50,000, even more preferably between about 25,000 to about 40,000.

The polycarbonates should have light transmittance of at least about 85%, more preferably at least about 90% and a C_{g} of less than about 60 Brewsters, more preferably less than 50 Brewsters. The polycarbonates preferably have a Cₘ of below about 3,000 Brewsters, even more preferably below about 2,500 Brewsters.

The desired optical article may be obtained by molding the polycarbonate or polycarbonate blend by injection molding, compression molding, extrusion methods and solution casting methods. Injection molding is the more preferred method of forming the article.

The methods of making the polycarbonates, end use applications, and additives that may be blended with the polycarbonates are the same as those described in section I of this specification, in reference to the polycarbonate suitable for use in an optical article.

As mentioned in reference to the polycarbonates in section I of this specification, the polycarbonate of the further aspect of the invention as defined in section II, and the optical articles made therefrom, may function as the medium for data storage, as in CD audio, CD ROM and DVD, i.e. the data may be fixed onto or into the polycarbonate. The polycarbonate may also function as the substrate onto which a data storage medium is applied. Further, some combination of both functions may be employed in a single device, as for instance when the polycarbonate is imprinted with tracking to aid in reading a data storage medium which is applied to the polycarbonate.

Experimental Section

The following examples are put forth so as to provide those of ordinary skill in the art with a complete disclosure and description of how the compositions of matter and methods claimed herein are made and evaluated, and not intended to limit the scope of what the inventors regard as their invention. Efforts have been made to insure accuracy with respect to numbers (e.g., amounts, temperatures, etc.) but some error and deviations should be accounted for. Unless indicated otherwise, parts are by weight, temperature is in ° C. or is at room temperature and pressure is at or near atmospheric.

The materials and testing procedures used for the results shown herein are as follows:

Molecular weights are reported as number average (Mn) and weight average (Mw) in units of grams per mol (g/mol). Molecular weights were determined by gel permeation chromatography using an HP 1090 HPLC with two Polymer Labs Mixed Bed C columns at 40° C., a flowrate of 1 milliliter per minute (ml/min), using chloroform as solvent and a calibration based on polystyrene standards.

T_{g} values were determined by differential scanning calorimetry using a Perkin Elmer DSC7. The T_{g} was calculated based on the ½Cp method using a heating ramp of 20° C./min.

C_{g} values were determined as follows. The polycarbonate (7.0 grams) was charged to a heated mold having dimensions 5.0×0.5 inches and compression molded at 120° C. above its glass transition temperature while being subjected to applied pressure starting at 0 and ending at 2000 pounds using a standard compression molding device. After the required amount of time under these conditions the mold was allowed to cool and the molded test bar removed with the aid of a Carver press. The molded test bar was then inspected under a polaroscope and an observation area on the test bar located. Selection of the observation area was based on lack of birefringence observed and sufficient distance from the ends or sides of the test bar. The sample was then mounted in a device designed to apply a known amount of force vertically along the bar while the observation area of the bar was irradiated with appropriately polarized light. The bar was then subjected to six levels of applied stress and the birefringence at each level measured with the aid of a Babinet compensator. Plotting birefringence versus stress affords a line whose slope is equal to the stress optical coefficient C_{g}.

Water absorption (% H₂O) was determined by the following method which is similar to ASTM D570, but modified to account for the variable thickness of the parts described in these examples. The plastic part (typically a compression-molded bar used for a C_{g} measurement) or injection-molded compact disk was dried in a vacuum for over 1 week. The sample was removed periodically and weighed to determine if it was dry (i.e. stopped loosing mass). The sample was removed from the oven, allowed to equilibrate to room temperature in a desiccator, and the dry weight was recorded. The sample was immersed in a water bath at room temperature. The sample was removed periodically from the bath, the surface was blotted dry, and the weight recorded. The sample was repeatedly immersed and the weight measured until the sample became substantially saturated. The sample was considered substantially saturated or at “Equilibrium” when the increase in weight in a 2 week period averaged less than 1% of the total increase in weight (as described in ASTM method D570-98 section 7.4). Diffusion coefficients were obtained by plotting the mass of water absorbed, Mᵤₚₜₐₖₑ, versus time, t, in units of seconds and fitting this curve to the following equation (expanded to the first 10 terms):

$${M}_{u p t a k e} / {M}_{e q} = 1 - {\sum }_{n = 0}^{∞} \{ 8 / {( 2 n + 1 )}^{2} {π}^{2} exp ( - {D ( 2 n + 1 )}^{2} {π}^{2} t / ( 4 {L}^{2} ) ) \}$$

where M_{eq} is the mass of water absorbed at equilibrium in units of grams, D is the diffusivity in units of cm²/s and L is the part thickness in units of cm.

The dimensional stability (the sensitivity of polycarbonate disks to warpage through water absorption) was obtained by measuring radial tilt and vertical deviation as a function of disk radius using a Dr. Shenk Prometeus MT136E optical disk tester. Polycarbonate substrates (120 mm diameter, 1.2 mm thickness) were molded using a CD stamper, metalized with aluminum, and lacquered (on top of the metal layer) with a UV-cured acrylate. Disks were then dried in a vacuum for over 1 week. The sample was removed from the oven, allowed to equilibrate to room temperature in a desiccator, and the initial values of radial tilt and vertical deviation were recorded. The sample was then immersed in a water bath at room temperature. The sample was removed periodically from the bath, the surface was blotted dry, and the radial tilt and vertical deviation recorded. The sample was repeatedly immersed in water and the radial tilt and vertical deviation measured until the sample reached equilibrium—usually about 2 days. Due to the part-to-part variability in initial values of tilt and vertical deviation due to molding variability, it was useful to normalize the data by either dividing or subtracting the vertical deviation data by the initial value at time 0. By mathematically correcting or “normalizing” the variability in the molding process, the dimensional stability performance of the new materials could be more readily assessed.

Descriptions of Polymer Synthesis:

Preparation of BCC Homopolycarbonate (LF1 Process):

Into a 500 mL Morton flask was placed BCC (29.6 g, 100 mmol), 125 mL methylene chloride and 90 mL of water. The pH was adjusted to 12.5 with 50 wt % sodium hydroxide (NaOH). Phosgene was added at 0.6 g/min, at 10.0 g (100 mmol), p-cumylphenol (1.06 g, 5 mol %) was added and phosgene was continued until 12.3 g (20 mol % excess) added. The pH was lowered to 10.5 (with phosgene) at which point 25 uL of triethylamine (TEA) added followed 5 min later with 25 uL more TEA. The chloroformates lasted about 8 min from the original TEA addition. An additional 75 uL of TEA added (125 uL total, about 1 mol %) followed by 4.5 g more phosgene. The reaction mixture is tested for chloroformates. If present they are hydrolyzed by addition of DMBA (5 uL) (dimethylbutylamine). The polymer solution was separated from the brine, washed with aqueous hydrochloric acid (HCl), washed with water and steam crumbed in a blender. T_{g}=140° C., Mw=35,900 (Polystyrene standards).

Preparation of BCC/BPA (50/50) Copolycarbonate (LF2 Process):

Into a 500 mL Morton flask was placed BCC (14.8 g, 50 mmol), BPA (11.4 g, 50 mmol), 125 mL methylene chloride and 90 mL of water. The pH was adjusted to 11 with 50 wt % NaOH. Phosgene was added at 0.6 g/min, at 10.0 g (100 mmol), p-cumylphenol (1.48 g, 7 mol %) was added and phosgene was continued until 12.3 g (20 mol % excess) added. The pH was lowered to 10.5 (with phosgene) at which point 25 uL of TEA added followed 5 min later with 25 uL more TEA. The chloroformates lasted about 18 min from the original TEA addition. An additional 75 uL of TEA added (125 uL total, about 1 mol %) followed by 4.5 g more phosgene. The reaction mixture was tested for chloroformates. If present they were hydrolyzed by addition of DMBA (5 uL) (dimethylbutylamine). The polymer solution was separated from the brine, washed with aqueous HCl, washed with water and steam crumbed in a blender. T_{g}=140° C., Mw=27,700 (Polystyrene standards).

Preparation of TMBPA Homopolycarbonate (LF3 Process):

Into a 500 mL Morton flask was placed TMBPA (28.6 g, 100 mmol), 120 mL methylene chloride, 90 mL of water and MTBA (0.5 mL of a 75 wt % aqueous solution). The pH was adjusted to 12.0 with 50 wt % NaOH. Phosgene was added at 0.6 g/min, at 11.2 g (112 mmol, 10 mol % excess), p-cumylphenol (1.06 g, 5 mol %) was added and reaction stirred for 3 min. 100 uL of DMBA was added and the chloroformates lasted about 15 min. The polymer solution was separated from the brine, washed with aqueous HCl, washed with water and steam crumbed in a blender. T_{g}==200° C., Mw=32,400 (Polystyrene standards).

The following polymers listed in Table 1 were prepared by the LF1 process:

DMBPA Homopolycarbonate

BPI Homopolycarbonate

DEBPA Homopolycarbonate

BisAP Homopolycarbonate

DmbisAP Homopolycarbonate

DMBPI Homopolycarbonate

DsBBPA Homopolycarbonate

DIPPBPA Homopolycarbonate

BPZ Homopolycarbonate

SBI/BPM Copolycarbonate at 50 mol % SBI

DESBI/BPM Copolycarbonate at 50 mol % DESBI

BCC/BPA Copolycarbonates at 80, 60 and 40 mol % BCC

BCC/DsBBPA Copolycarbonate at 10 mol % DsB-BPA

The following polymers listed in Table 1 were prepared by the LF2 process:

BPA Homopolycarbonate

BCC/BPA Copolycarbonate at 50 mol % BCC

DMBPA/BPA Copolycarbonate at 50 mol % DMBPA

BPA/DsBBPA Copolycarbonate at 10 mol % DsB-BPA

Preparation of di-t-butyl BPA Polycarbonate (LX1 Process):

A 250 mL glass melt polymerization reactor, which had been previously passivated by acid washing, rinsing and drying overnight at 120° C., was loaded with 46.46 g (0.14 mol) of di-t-butyl BPA and 32.15 g (0.15 mol) of diphenyl carbonate. A 316 stainless steel helixing stirrer was suspended in the powder and 102 microliters of tetramethylammonium hydroxide in the form of a 1.0 M aqueous solution and 1023 microliters of sodium hydroxide in the form of a 0.001 M aqueous solution were added. The vessel was then evacuated and purged with nitrogen three times and heated to 180° C., whereupon the reaction mixture melted. Upon complete melting, the mixture was allowed to thermally equilibrate for 15 minutes after which stirring at 50 rpm was begun. The temperature was raised to 230° C. and the pressure reduced to 170 millibar, whereupon phenol began to distill from the reactor. After 60 minutes, polymerization was continued further with the following temperature/pressure profile: 270° C./20 millibar (30 minutes); 290° C./3.5 millibar (30 minutes); 310° C./0.3 millibar (230 minutes). At the completion of polymerization, the reactor was restored to ambient pressure with nitrogen and the polymer pulled from the reactor. GPC results (based on polycarbonate standards): Mw 54700, Mn 18034.

Preparation of DMBPA-co-BCC (50/50) Polycarbonate (LX1 Process):

A 1-liter glass melt polymerization reactor equipped with a mechanical stirrer, heating mantle, vacuum and nitrogen inlets, and a heat-jacketed overhead condenser with a phenol receiving flask, and which had been previously passivated by acid washing, rinsing and drying overnight at 70° C., was loaded with 110.53 g (516 mmol) of diphenyl carbonate, 63.58 g (248 mmol) of DMBPA, and 73.52 g (248 mmol) of BCC. A 316 stainless steel helixing stirrer was suspended in the powder and 372 microliters of tetramethylammonium hydroxide in the form of a 1.0 M aqueous solution and 744 microliters of sodium hydroxide in the form of a 0.001 M aqueous solution were added. The vessel was then evacuated and purged with nitrogen three times, then heated to 180° C. whereupon the reaction mixture melted and was allowed to thermally equilibrate for 10 minutes. The temperature was then raised to 230° C., the pressure reduced to 170 millibar, and the mixture stirred at 50 rpm for 60 minutes. Polymerization was continued further with the following temperature/pressure profile: 27⁰° C./20 millibar (30 minutes); 300° C./3.4 millibar (30 minutes); 310° C./0.3 millibar (30 minutes). The polymer was then dropped from the reactor and cooled to give 104 g of transparent material (Mn=20400, Mw=50000, T_{g}=134° C.).

Preparation of Substituted Bisphenol A Based Polycarbonates (LX2 Process):

Melt phase polycondensation reactions were carried out with 5 and 10 mole % of co-monomer with bisphenol A (BPA) and diphenyl carbonate (DPC). Mole % is defined as 100×(mole co-monomer/(mole BPA+mole co-monomer)). The co-monomers that were used were 2,2-(bis-3-methyl-4-hydroxyphenyl)propane, 2,2-(bis-3-ethyl-4-hydroxyphenyl) propane, 2,2-(bis-3-isopropyl-4-hydroxyphenyl)propane, 2,2-(bis-3-sec.butyl-4-hydroxyphenyl)propane, 2,2-(bis-3-tert.butyl-4-hydroxyphenyl)propane, 2,2-(bis-3-cyclohexyl-4-hydroxyphenyl)propane, and 2,2-(bis-3-phenyl-4-hydroxyphenyl)propane. The total amount (moles) of DPC equaled 1.08×(BPA+co-monomer (in moles)). As catalysts, tetramethylammonium hydroxide (TMAH) (2.5×10⁻⁴ mole/mole (BPA+co-monomer)) and NaOH (7.5×10⁻⁶ mole/mole(BPA+co-monomer)) were added as an aqueous solution. Thus for a typical polymerization, BPA (22.20 g), 2,2-(bis-3-isopropyl-4-hydroxyphenyl)propane (3.38 g), and DPC (25.00 g) were weighed into a glass tube that was previously conditioned in 1 N HCl overnight and rinsed excessively with Milli-Q water and acetone and dried with air. After addition of the monomers, 100 ml of catalyst solution was added (8.2 mM NaOH and 274 mM TMAH). The vessel was then evacuated and purged with nitrogen three times and heated to 180° C., whereupon the reaction mixture melted. Upon complete melting, the mixture was allowed to thermally equilibrate for 10 minutes after which stirring was begun. The pressure was reduced to 130 mbar, whereupon phenol began to distill from the reactor. After 30 minutes, polymerization was continued further with the following temperature/pressure profile: 180° C./65 mbar (30 min.); 220° C./65 mbar (30 min); 220° C./13 mbar (30 min); 270° C./13 mbar (30 min); 270° C./8 mbar (30 min); 270° C./8 mbar (30 min); 300° C./1 mbar (60 min). At the end of the reaction, the reactor was brought back to atmospheric pressure with a gentle nitrogen flow and the polymer was harvested as a colorless to slightly colored, transparent material. To purify, the copolymer was dissolved in chloroform and reprecipitated in methanol. Finally, the polymer was isolated by filtration and dried overnight under vacuum at 50° C.

Preparation of DMBPA/BPA (50/50) Copolycarbonate (LX3):

A 250 mL glass melt polymerization reactor, which had been previously passivated by acid washing, rinsing and drying overnight at 120° C., was loaded with 71.08 g (0.28 mol) of Polycarbonate oligomer with Mw=4000 g/mole, 71.66 g (0.28 mol) of dimethyl-bisphenol A (DMBPA), and 62.28 g (0.29 mol) of diphenyl carbonate. A 316 stainless steel helixing stirrer was suspended in the powder and 419 microliters of tetramethylammonium hydroxide in the form of a 1.0 M aqueous solution and 419 microliters of sodium hydroxide in the form of a 0.001 M aqueous solution were added. The vessel was then evacuated and purged with nitrogen three times and heated to 180° C., whereupon the reaction mixture melted. Upon complete melting, the mixture was allowed to thermally equilibrate for 15 minutes after which stirring at 50 rpm was begun. The temperature was raised to 230° C. and the pressure reduced to 170 millibar, whereupon phenol began to distill from the reactor. After 60 minutes, polymerization was continued further with the following temperature/pressure profile: 270° C./20 millibar (30 minutes); 290° C./3.5 millibar (30 minutes); 310° C./0.3 millibar (60 minutes). At the completion of polymerization, the reactor was restored to ambient pressure with nitrogen and the polymer pulled from the reactor. GPC results (based on polycarbonate standards): 84700 Mw, 24700 Mn.

Preparation of Blends and Optical Articles of DMBPA or BCC Polycarbonate with BPA Polycarbonate (Examples 46-48)

BPA polycarbonate (LEXAN OQ1050C obtained from General Electric) and DMBPA polymer and/or BCC polymer were premixed in a HENSCHEL high intensity mixer and fed into a 28 mm WP extruder equipped with a mild screw design and extruded at barrel temperatures of from about 260° C. to about 280° C. at a screw speed of 300 rpm and a throughput of from about 10 to 20 lbs/hr. For example 46 (50:50 BCC:OQ1050), 425 g BCC polycarbonate (7 mole % chainstopper, Mw of 28,000 grams/mole) and 425 g BPA polycarbonate (LEXAN OQ 1050C, made by GENERAL ELECTRIC) were premixed and extruded. For example 47 (53:47 DMBPA:OQ1050), 447 g DMBPA polycarbonate and 403 g OQ1050C were premixed and extruded. For example 48 (49:28:22 DMBPA:BCC:OQ1050C), 420 g DMBPA polycarbonate, 241 g BCC polycarbonate, and 190 g OQ1050C were premixed and extruded. The resulting pellets were then injection molded into compact disks using an Engel 275 ton injection molding machine. The optical transmission for all the disks was greater than 84% at 630 nm using an HP UV-visible spectrophotomer. The high transmittance of these examples supports the conclusion that the polymers are miscible.

Preparation of 5,5′diethylspirobiindane (DESBI)

5,5′diethyl SBI was prepared via the double Fries rearrangement of SBI diacetate followed by reduction of 5,5′-diacety SBI.

SBI-diacetate (10.0 g, 25.5 mmol) and aluminum chloride (20 g, 150 mmol) were mixed well and heated to 170° C. for four minutes. The resulting reddish foam was then cooled to 0° C. and carefully diluted with cold water. The crude product was extracted with ethyl acetate, washed with brine, and dried with sodium sulfate to recover a dark foam. Upon trituration with acetonitrile, the product was recovered as an off-white solid (4 g, 40% yield). Melting Point=212-214° C. Nuclear Magnetic Resonance Spectroscopy (NMR) was consistent with desired 5,5′-diacetyl SBI. At 0° C., ethylchloroformate (5.87 ml, 61.4 mmol) dissolved in 35 ml of tetrahydrofuran (THF) was added to a solution of 5,5′-diacetyl SBI (10 g, 25.5 mmol), triethylamine (8.53 ml, 61.2 mmol), and 85 ml of THF. The mixture was stirred for an additional 30 minutes at 0° C. and then filtered. At 0° C., the filtrate was added dropwise to a mixture of sodium borohydride (7.7 g, 203 mmol) and 100 mL of water. The reaction was stirred at room temperature for one hour, poured into water, neutralized with 10% hydrochloric acid, and extracted with ethyl acetate. The organics were washed with brine, and dried with sodium sulfate to recover a white solid. The crude product was dissolved in ethyl acetate and toluene. Ethyl acetate was removed in vacuo. The remaining mixture was filtered, and the filtercake was washed with hexane to recover a white solid (6.9 g, 74% yield). MP=236-239° C. NMR is consistent with desired 5,5′-diethyl SBI.

Polymer characteristics of the various materials of the present invention are listed in Tables 1 and 2. The polymers in Table 1 were synthesized using the interfacial polymerization process, while those in Table 2 were synthesized using the melt process. Of critical interest to the performance of optical disks are the resin molecular weight and glass transition temperature (T_{g}), water uptake and diffusivity, and stress-optical coefficient (C_{g}). The T_{g} data indicate that the o-substituted bisphenol polycarbonates generally have lower T_{g}'s than their respective non-substituted analogues. For example, the T_{g}'s of the DMBPA- and BCC-based polycarbonates are about 20-30° C. lower than those from BPA and BPZ. Copolymers from these monomers have utility as optical disk substrates due to the lower T_{g} and reduced melt viscosity of the resin during molding, which in turn improves optical birefringence and pit-groove replication. For this reason, the copolycarbonates of Examples 7, 8 and 15 are preferable in that the T_{g} is reduced compared to BPA-PC.

Stress-optical coefficients of the substituted polycarbonates are also reduced compared to BPA-PC (81 Brewsters). The homopolymers of BCC, DsBBPA, DIPPBPA, DEBPA, and DTBBPA (C_{g}=24 for Example 25) all have substantially better C_{g} values which results in lower optical birefringence in the optical disk when the resins are molded under conditions that result in similar residual stress.

TABLE 1
Polymer characteristics of BPA and alkylated BPA based
copolycarbonates (interfacial process)

| | | | | |
|---|---|---|---|---|
| | | | H2O Uptake | |
| Tg | Mw | Mn | (% at | Diffusivity |

| | | | | | | | |
|---|---|---|---|---|---|---|---|
| Ex. # | Process | Composition | (° C.) | (Kg/mol) | equilibrium) | (×10\hat{ }8 cm2/s) | Cg |

Comparative Examples

| | | | | | | | | |
|---|---|---|---|---|---|---|---|---|
| C1 | LF2 | OQ1030L (BPA-PC | 142 | 28.3 | 11.8 | 0.33 | 4.6 | 81 |
| | | with PCP endcap) | | | | | | |
| C2 | LF2 | BPZ | 169 | 32.2 | 12.8 | 0.28 | 2.5 | |
| C3 | LF1 | BisAP | 179 | 45.81 | 8.5 | 0.43 | 4.9 | |
| C4 | LF1 | BPI | 224 | 37.21 | 1.9 | 0.35 | 8.3 | |
| C5 | LF3 | TMBPA | 200 | 32.41 | 2.6 | 0.79 | 6.9 | 60 |
| C6 | LF1 | BPM:SBI (50:50) | 143 | 45.6 | 8.2 | 0.26 | | |

Substituted bisphenol polycarbonate samples

| | | | | | | | | |
|---|---|---|---|---|---|---|---|---|
| 1 | LF1 | BCC | 140 | 35.9 | 13.1 | 0.22 | 0.4 | 47 |
| 2 | LF1 | BCC:BPA (80:20) | 138 | 34.80 | 14.7 | 0.27 | 0.87 | |
| 3 | LF1 | BCC:BPA (60:40) | 139 | 33.30 | 14.7 | 0.28 | | |
| 4 | LF2 | BCC:BPA (50:50) | 140 | 27.7 | 11.7 | 0.28 | 2.3 | 61 |
| 5 | LF1 | BCC:BPA (40:60) | 140 | 33.2 | 14.5 | 0.30 | | |
| 6 | LF1 | DsBBPA | 63 | 44.6 | 13.6 | 0.11 | 5.5 | 32 |
| 7 | LF2 | DsBBPA:BPA (10:90) | 127 | 30.5 | 10.3 | | | |
| 8 | LF1 | DsBBPA:BCC (10:90) | 127 | 31.7 | 11.0 | | | |
| 9 | LF1 | DIPPBPA | 80 | 42.9 | 14.2 | 0.10 | 4.4 | 35 |
| 10 | LF1 | DEBPA | 72 | 38.5 | 13.1 | 0.17 | 4.5 | 50 |
| 11 | LF1 | DMBisAP | 155 | 43.9 | 17.3 | 0.34 | 2.2 | |
| 12 | LF1 | DMBPI | 196 | 46.1 | 15.1 | 0.34 | 4.3 | |
| 13 | LF1 | BPM:DESBI (50:50) | 129 | 33.8 | 6.6 | 0.16 | | |
| 14 | LF1 | DMBPA | 118 | 31.0 | 12.1 | 0.24 | 1.9 | 66 |
| 15 | LF2 | BPA:DMBPA (50:50) | 129 | 31.1 | 12.2 | 0.29 | 2.3 | |

Table 1 also illustrates the superior water absorption properties of the copolycarbonates of the present invention relative to analogous polycarbonate materials. The substituted polycarbonate materials display both a low water absorption (water uptake at 1 week and at equilibrium) and a low kinetic water affinity (diffusivity, related to permeability). The water absorption and diffusivity are thought to be important parameters for determining a material's suitability for use in the manufacture of optical devices such as digital versatile disks (DVD's) and substrates for DVR disks. For these optical disk formats, performance is related to disk flatness, and disk flatness is in turn dependent upon the initial flatness of the polycarbonate substate out of the mold and its sensitivity (rate of water uptake) to atmospheric temperature and humidity conditions. Comparison of the water diffusivity, and the weight percent water absorption at 1 week and at equilibrium among molded parts from different materials permits evaluation of this key material property.

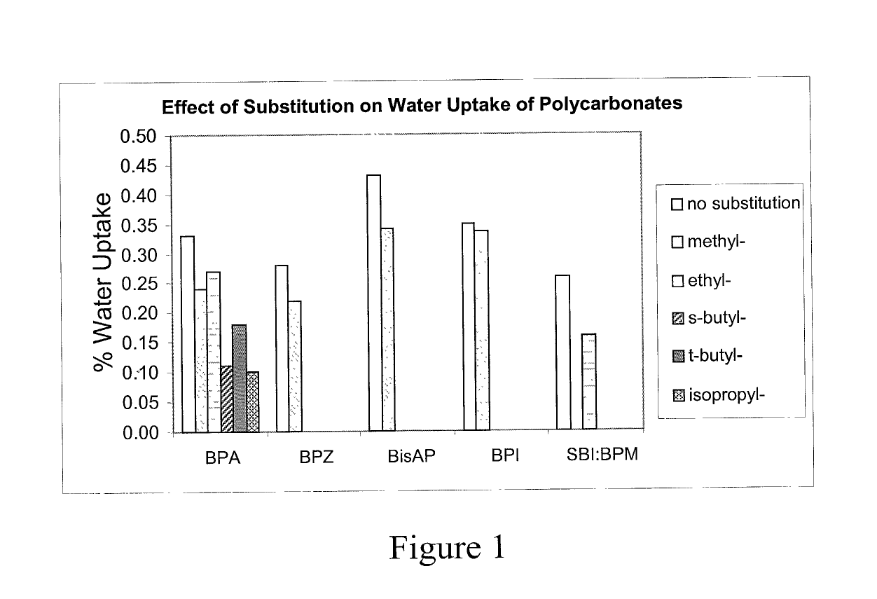

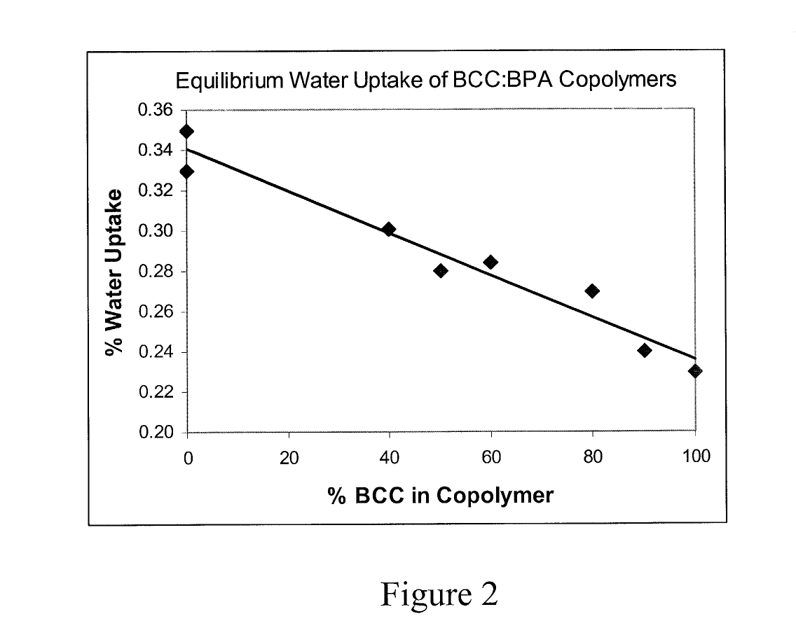

For the DVR optical disk format, in which a 100 micron plastic film is bonded to a 1.1 to 1.2 mm plastic substrate, disk tilt (or warpage) results when the substrate and film absorb water. The rate of water uptake is not as important as the equilibrium concentration of water in the substrate and the mismatch in water uptake between the substrate and film. Thus, for the DVR format, it is desirable to have resin materials with low equilibrium water uptake. The equilibrium water absorption for a series of modified polycarbonates is shown in FIG. 1. The water absorption trends lower as the length of the alkyl substituent is increased. The effect is shown to be general for a number of bisphenols including BPA, BPZ, BisAP, BPI and SBI. Of particular interest are dimethyl-BPA, dibutyl-BPA, and dimethyl-BPZ (BCC) due to their lower C_{g}, T_{g}'s that are within an acceptable range, and lower water uptake. The equilibrium water uptake can be adjusted through copolymerization of mixtures of BPA with the substituted bisphenols. For example, copolymers of BCC with BPA (Examples 2-5) demonstrate that the equilibrium water uptake varies linearly with composition as shown in FIG. 2.

For DVD-recordable and rewriteable (DVDR and DVD-RW) and high density DVD (HD-DVD) optical disk formats where tilt specifications are also tighter than they are for CD and DVD, a material with low equilibrium water uptake is also desireable to improve the dimensional stability. In addition, the rate of water uptake, as expressed by the diffusivity, is also important as it can affect the concentration of water, and therefore tilt that occurs in a molded and metalized DVD half-substrates (0.6 mm thickness) prior to bonding. With BPA-PC, it is a common practice in the industry to equilibrate DVD half-substrates for several days in a controlled atmosphere prior to bonding in order to reduce the effect of water-induced tilt. This practice can be eliminated if the entire molding and bonding process were either performed very quickly or in a controlled atmosphere in order to reduce the amount of water allowed to absorb into the substrate. In practice, this is either very difficult or very expensive. The materials of the present invention, with their lower water diffusivity have utility in these applications because the amount of water that is absorbed in the first few hours of exposure to water is very much reduced compared to BPA-PC. Upon exposure to water, the polymers in Examples 1-4 initially have very slow water sorption kinetics, a characteristic that is described by the water diffusion coefficient. The polycarbonates from BCC (Example 1) are especially desirable for these applications because it has a diffusivity that is nearly 10 times lower (0.4×10ˆ 8 cm²/s) than for BPA-PC (4.6×10ˆ 8 cm²/s).

Several of the copolycarbonates from Table 1 as well as some others which were difficult to polymerize interfacially were also polymerized by the melt process. Properties of these polymers are shown in Table 2. Molecular weights and glass transition temperatures of the melt-polymerized materials were comparable to their interfacially polymerized analogues. Of particular interest are several copolymers that were polymerized by the melt that were not easily polymerized interfacially. Example 25, DtBBPA-PC was difficult to polymerize interfacially, yet high molecular weight was achieved via the melt process.

It was also surprising to find that the glass transition of DtBBPA-PC is 120° C., closer to the T_{g} of DMBPA-PC than to its isomer, DsBBPA, Example 6, which has a T_{g} nearly 60° C. lower. Given its relatively high T_{g}, within the preferred range of T_{g}'s for optical disk substrates, copolymers of DtBBPA with BPA would find utility in optical disk formats requiring low water uptake and low birefringence. The C_{g} of Example 25 is 24 Brewsters, the lowest of any of the substituted polycarbonates of this invention.

TABLE 2
Characteristics of copolycarbonates (melt process)

| | | |
|---|---|---|
| Tg | Mw | Mn |

| | | | | |
|---|---|---|---|---|
| Example | Process | Composition | (° C.) | (Kg/mol) |

Comparative Examples

| | | | | | |
|---|---|---|---|---|---|
| C7 | LX | OQ1020C (BPA-PC with | 142 | 30.1 | 12.8 |
| | | 82% phenyl endcap) | | | |
| C8 | *LX3 | BPA | 150 | 54.0 | 22.7 |

Substituted bisphenol polycarbonate samples

| | | | | | |
|---|---|---|---|---|---|
| 16 | LX1 | BCC | 134 | 26.1 | 12.0 |
| 17 | LX2 | DEBPA:BPA (5:95) | 141 | 44.9 | 21.2 |
| 18 | LX2 | DEBPA:BPA (9.4:90.6) | 134 | 39.7 | 21.4 |
| 19 | LX2 | DiPPBPA:BPA (4.8:95.2) | 149 | 30.2 | 13.8 |
| 20 | LX2 | DiPPBPA:BPA (9.7:90.3) | 134 | 45.0 | 21.7 |
| 21 | LX2 | DsBBPA:BPA (1.7:98.3) | 144 | 70.8 | 34.1 |
| 22 | LX2 | DsBBPA:BPA (10:90) | 138 | 89.4 | 39.7 |
| 23 | LX1 | DsBBPA:BPA (10:90) | 130 | 29.4 | 12.9 |
| 24 | LX | BCC:DsBBPA (90:10) | 130 | 35.1 | 14.4 |
| 25 | LX1 | DtBBPA | 120 | 55.0 | 21.5 |
| 26 | LX2 | DtBBPA:BPA (4.6:95.4) | 141 | 31.1 | 15.2 |
| 27 | LX2 | DtBBPA:BPA (8.6:91.4) | 144 | 68.6 | 30.5 |
| 28 | LX2 | DCHBPA:BPA (4.6:95.4) | 143 | 44.5 | 21.0 |
| 29 | LX2 | DCHBPA:BPA (9.3:90.7) | 140 | 37.0 | 19.3 |
| 30 | LX2 | DPBPA:BPA (5.2:94.8) | 145 | 48.6 | 20.6 |
| 31 | LX2 | DPBPA:BPA (10:90) | 141 | 43.1 | 18.1 |
| 32 | LX2 | BPZ:BPA (5.8:94.2) | 130 | 13.1 | 7.6 |
| 33 | LX2 | BPZ:BPA (11.8:88.2) | 156 | 101.6 | 40.8 |
| 34 | LX2 | BCC:BPA (5.7:94.3) | 160 | 60.0 | 24.0 |
| 35 | LX2 | BCC:BPA (11.8:88.2) | 154 | 46.5 | 18.0 |
| 36 | LX1 | DMBPA | 122 | 46.3 | 18.9 |
| 37 | LX2 | DMBPA:BPA (4.7:95.3) | 132 | 33.7 | 15.8 |
| 38 | LX2 | DMBPA:BPA (9.7:90.3) | 144 | 46.3 | 18.4 |
| 39 | *LX3 | BPA:DMBPA (25:75) | 128 | 55.5 | 21.0 |
| 40 | *LX3 | BPA:DMBPA (50:50) | 132 | 48.6 | 20.4 |
| 41 | *LX3 | BPA:DMBPA (75:25) | 137 | 33.8 | 15.8 |
| 42 | LX1 | BCC:DMBPA (50:50) | 134 | 50.0 | 20.4 |
| 43 | LX1 | BCC:DMBPA (75:25) | 137 | 49.5 | 20.1 |
| 44 | LX1 | BPA:BCC:DMBPA | 137 | 42.3 | 21.1 |
| | | (25:50:25) | | | |
| 45 | LX1 | BPA:BCC:DMBPA | 138.9 | 47.7 | 19.8 |
| | | (50:25:25) | | | |

Several DMBPA:BPA and DMBPA:BCC copolymers were synthesized (Examples 14 and 15 interfacially, and Examples 36-45 via the melt process); the formulations and resulting molecular weights and measured T_{g}'s are given in Tables 1 and 2. Examples 14, 15 and 42 were compression molded and water uptake was measured as a function of water soak time at 25° C. to obtain the percent water uptake at equilibrium (0.24%, 0.29% and 0.24%, respectively). The water absorption values were very similar to those for the BCC-PC homopolymer (Example 1). In addition, DMBPA-PC (Example 36) has a substantially lower T_{g} (122° C.) than BPA-PC (142-150° C) and BPA:BCC copolymers (138-140° C.). The lower T_{g} of DMBPA homopolymer and BPA copolymers allows for a lower melt viscosity and hence improved birefringence and pit-groove replication. It was found (RD28144 filed USPTO May 31, 2000) that incorporation of a softblock, DDDA (dodecanedioic acid), into BCC:BPA:DDDA copolymers improves the birefringence and replication properties of optical disks. The DMBPA:BCC:BPA copolymers in this invention would have enhanced flow relative to BPA-PC due to the lower T_{g} resulting in lower birefringence, and in addition, would have a lower equilibrium water uptake. DMBPA is both a softblock and a water absorption-lowering agent. Thus, a new composition is invented that has a more optimal combination of cost, T_{g}, flow, and water absorption than BCC:BPA copolymers and BCC:BPA:DDDA terpolymers, allowing for the manufacture of optical disks with improved pit-replication, birefringence and dimensional stability performance.

Several compositions incorporating BCC, DMBPA, and DsBBPA were molded into substrates in order to assess their utility in the DVR and recordable and rewriteable DVD formats.

TABLE 3
Performance of Compact Disks molded from DMBPA and BCC blends and copolymers

| | | | Tg | Mw | | % T at | IBR | | VBR |
|---|---|---|---|---|---|---|---|---|---|
| Ex. # | Process | Composition | (° C.) | (Kg/Mol) | Mn | 630 nm | Min. | Max. | Disk Avg |
| C1 | | OQ1050 (BPA-PC with | 142 | 28.3 | 11.8 | | 15 | 65 | 492.4 |
| | | PCP endcap) | | | | | | | |
| 4 | LF2 | BCC:BPA (50:50) | 140 | 27.7 | 11.7 | | −23 | 50 | 257 |
| 15 | LF | DMBPA:BPA (50:50) | 129 | 31.1 | 12.2 | | −30 | 71 | 384.7 |
| 7 | LF2 | DsBBPA:BPA (10:90) | 127 | 30.5 | 10.3 | 86.1 | −66 | 24 | 582 |
| 46 | **Blend | BCC:OQ1050 (50:50) | 141 | 26.7 | 12.5 | 84.5 | | | |
| 47 | **Blend | DMBPA:OQ1050 | 127 | 41.7 | 17.1 | 84.4 | | | |
| | | (50:50) | | | | | | | |
| 48 | **Blend | BCC:DMBPA:OQ1050 | 129 | 39.0 | 16.4 | 85.1 | | | |
| | | (25:50:25) | | | | | | | |

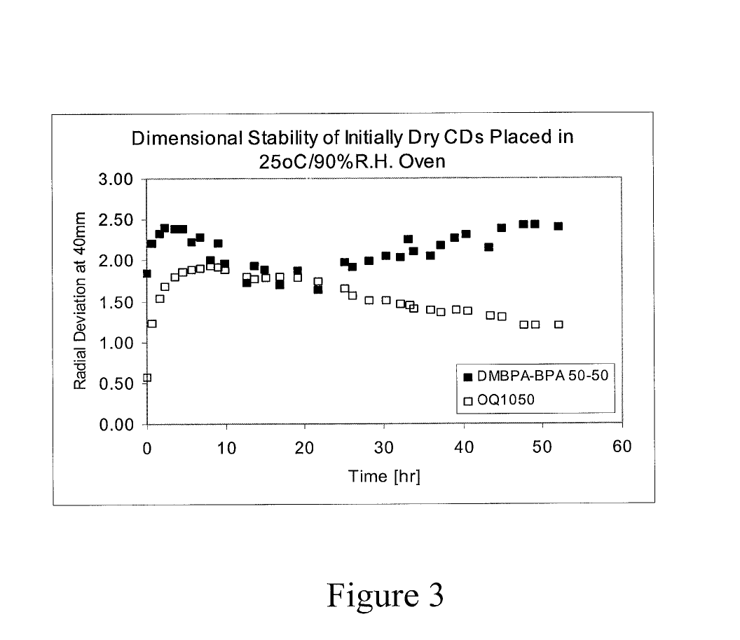

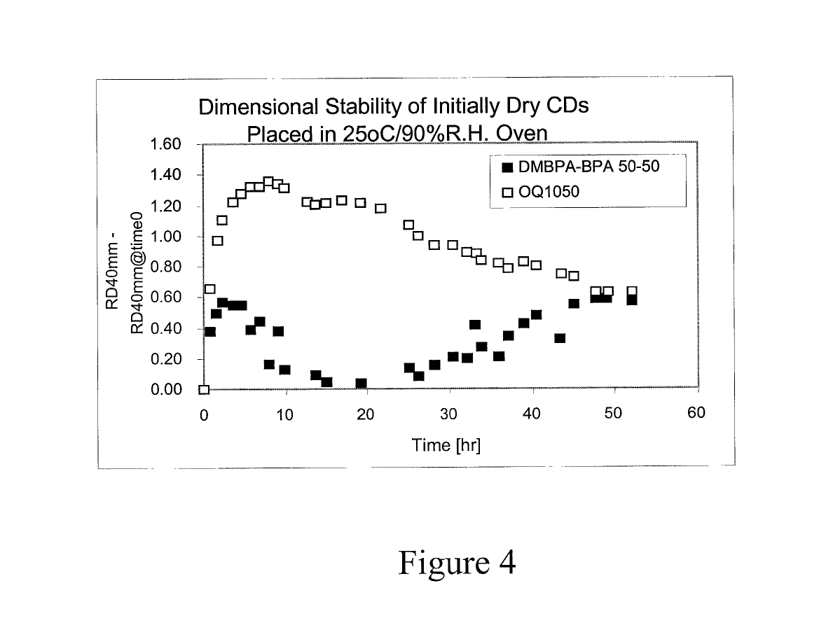

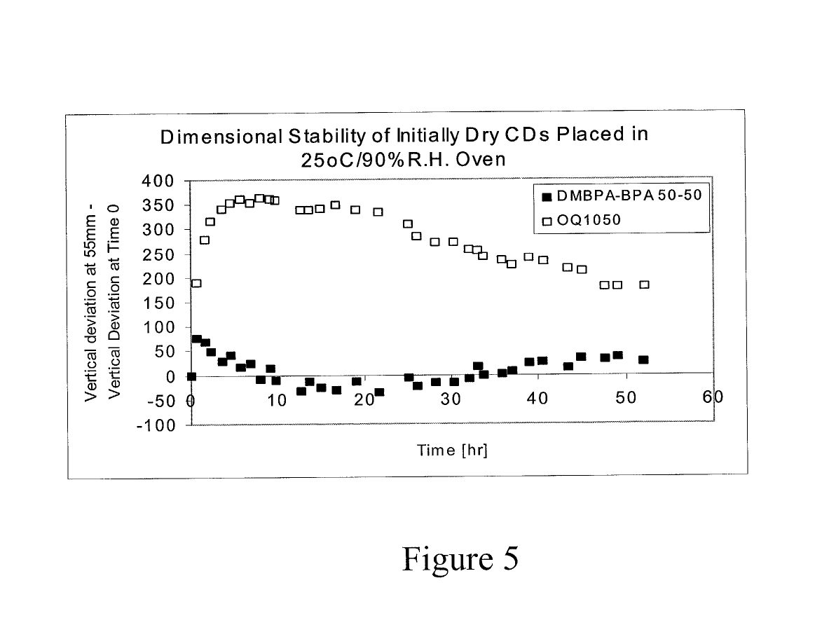

Copolymers of dimethyl-BPA-co-BPA (DMBPA:BPA) 50:50 copolymer and di-s-butyl-BPA-co-BPA (DsBBPA:BPA) 10/90 were polymerized interfacially (examples 15 and 7, respectively). The powder was extruded using a 28 mm WP extruder and molded into compact disks using a 275 ton Engel injection molder with a CD stamper. The disks were metalized and lacquered and then dried in a vacuum desicator at room temperature for 1 week and then placed in a humidity chamber at 25° C./90% r.h. The disks were removed periodically (every 1-2 hrs for 50 hrs) from the humidity chamber and tilt was measured using a Dr. Shenk optical disk test. Dimensional stability (tilt) data on the CDs are shown in FIGS. 3-5. The data are averages from 3 replicates of DMBPA:BPA copolymer and OQ1050 BPA-PC. FIG. 3, which shows radial deviation at 40 mm (near the CD center) indicates that DMBPA:BPA CDs generally have a higher radial deviation than the OQ1050 CDs. Presumably, the high initial tilt of the DMBPA:BPA disks, due to residual stresses molded into the parts, might be improved with molding process optimization. However, while most of the tilt for the copolymer CDs is present at the beginning of the test, the OQ1050 CDs showed a tremendous increase in radial deviation (from 0.5 to 2.0) in the first 10 hrs of the test and then recovered with time. FIG. 4, which shows the radial tilt at 40 mm normalized by substracting the initial radial deviation at time 0, more clearly illustrates that the DMBPA:BPA copolymer has a more stable radial tilt than OQ1050. The effect of a lower radial deviation was shown even more clearly when disk curvature data were plotted. Vertical deviation data at the outer radius (at 55 mm) of the CDs (also normalized by subtracting the value at time 0) are shown in FIG. 5. The change in vertical deviation at the outer radius of the CDs during the course of the humidity test is almost 400 microns for the OQ1050 CDs, but less than 100 microns for the DMBPA:BPA disks. This indicates that metalized and lacquered CDs molded from DMBPA:BPA, as with CDs from other low water absorbing PCs such as BCC-PC, can have better dimensional stability during humidity exposure than BPA-PC.

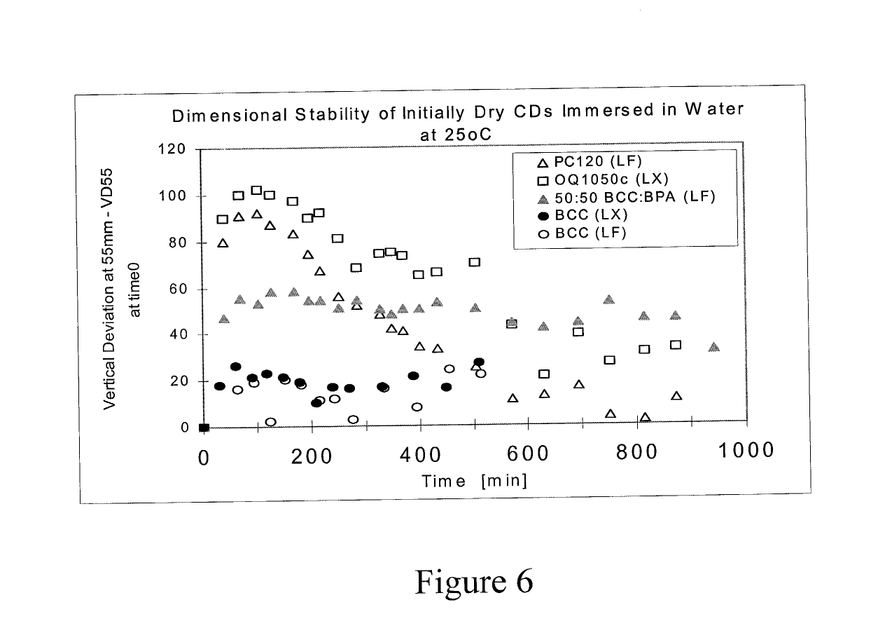

FIG. 6 indicates that CDs molded from BCC homopolymers produced by the melt (LX) or interfacial process (LF) have much improved dimensional stability upon exposure to water at 25° C. The vertical deviation at 55 mm for a disk molded from BPA-PC increased by over 100 microns during the water immersion test compared to only about 20 microns for the BCC homopolymer. FIG. 6 also shows that the 50:50 BCC:BPA copolymer also has improved dimensional stability compared to BPA-PC, though not as good as the BCC homopolymers.

Table 3 also indicates that the 50:50 BCC:BPA and DMBPA:BPA copolymers (Examples 4 and 15, respectively) have an improved (decreased) vertical birefringence (VBR) relative to BPA-PC (Example C1). Also notable are the decreased T_{g}'s of the DMBPA and DsBBPA copolymers and blends (Examples 15, 7, 47 and 48) which is expected to improve the replication of features (pits, grooves or bumps) in plastic substrates molded from these materials.

Examples 46-48 also demonstrate that blends of BCC polycarbonate and/or DMBPA polycarbonate with BPA polycarbonate possess single T_{g}'s and good (>84%) transparency.

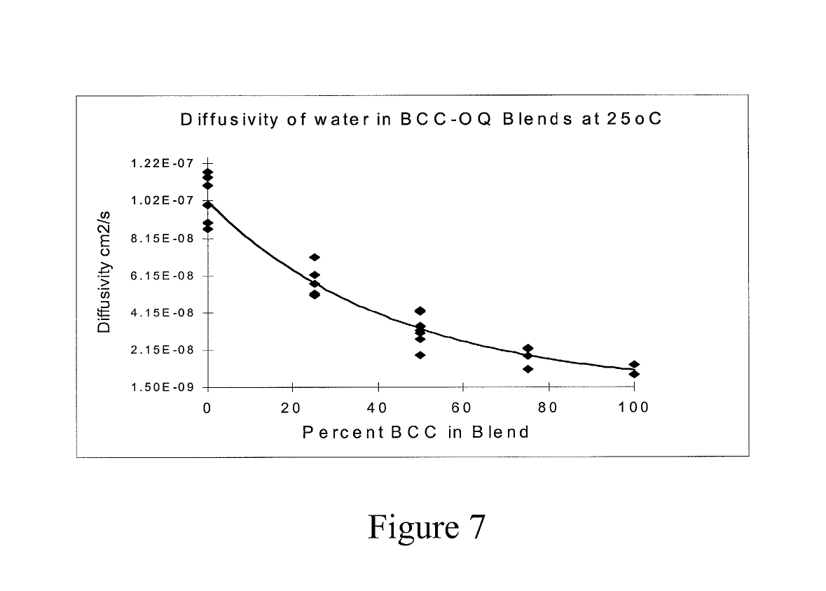

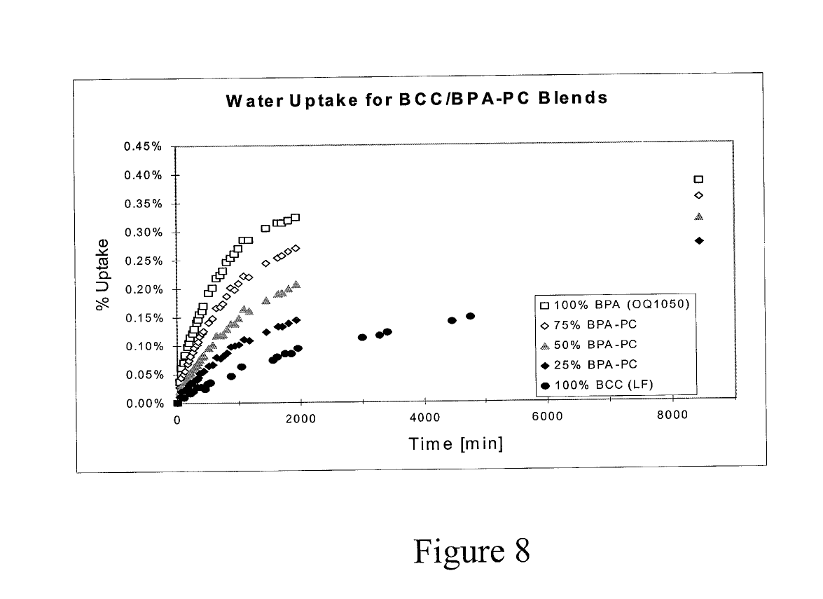

Optical discs molded from BCC-PC/BPA-PC blends also possess low water absorption and good dimensional stability. Water diffusivity measurements performed on this system also show that the water equilibrium uptake and diffusivity improve (decrease) as the concentration of BCC-PC increases in the blend as listed in Table 4. Surprisingly, this improvement is better than expected, ie. the concentration dependence of the water diffusion coefficient is nonlinear as shown in FIG. 7. At 50 wt % BCC-PC, the diffusion coefficient is 3±0.3×10⁻⁸ cm2/s which is surprisingly lower than the weighted average diffusivity of both homopolymers (1.2+0.2)/2×10⁻⁹ cm²/s=7×10⁻⁸ cm²/s. Data on BCC-BPA copolymers also show that the concentration dependence of the water absorption is nonlinear. As shown in FIG. 8, the rate of water absorption into CDs molded from BCC-PC/Lexan blends is slow. At times as long as 10 hours, BCC-PC absorbed less than 0.05% water, compared to 0.15% for BPA-PC. This indicates that copolymers containing BCC would perform well in high density recordable and rewriteable DVD formats where in-process (between the molding and bonding steps) dimensional stability is critical.

TABLE 4
Performance of Compact Disks Molded from BCC/BPA-PC Blends

| | | | | H2O Uptake | | % Change in Vertical |
|---|---|---|---|---|---|---|
| | | | Mw | % at | Diffusivity | Deviation |
| Ex. # | Process | Composition | (Kg/mol) | equilibrium) | (×10\hat{ }8 cm2/s | Maximum |
| 49 | LX | BPA-PC (OQ1050) | 27.4 | 0.38 | 8.65 | 72 |
| 50 | **Blend | BCC-OQ1050 | 26.7 | 0.33 | 3.20 | 62 |
| | | (50:50) | | | | |
| 51 | **Blend | BCC-OQ1050 | 26.2 | 0.3 | 1.80 | 18 |
| | | (75:25) | | | | |
| 52 | LX | BCC | 30.1 | 0.25 | 0.84 | 25 |
| 53 | LF | BPA-PC (PC120) | 33.1 | 0.36 | 9.00 | 58 |
| 54 | **Blend | BCC-PC120 | 32.3 | 0.34 | 5.10 | 59 |
| | | (25:75) | | | | |
| 55 | **Blend | BCC-PC120 | 32.1 | 0.32 | 2.70 | 21 |
| | | (50:50) | | | | |
| 56 | **Blend | BCC-PC120 | 30.9 | 0.29 | 1.10 | 17 |
| | | (75:25) | | | | |
| 57 | LF | BCC | 28.3 | 0.22 | 1.36 | 6 |

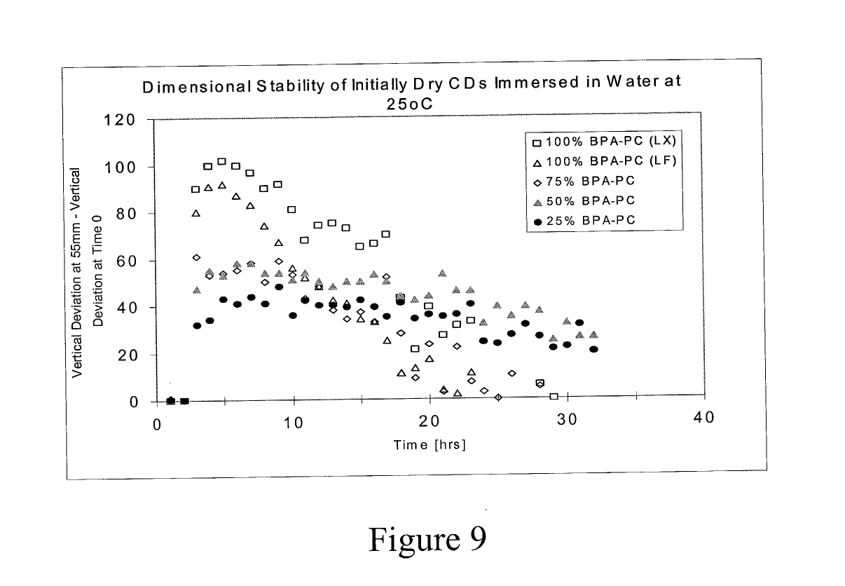

As shown in FIG. 9, the dimensional stability of BCC-PC/BPA-PC blends are also very good. The stability of BCC-PC homopolymer is shown to be substantially better than Lexan; blends of the two polymers are shown to have intermediate dimensional stability.

For each of the molded disks immersed in water, the percent change in vertical deviation (VD) at 55 mm was calculated as follows:

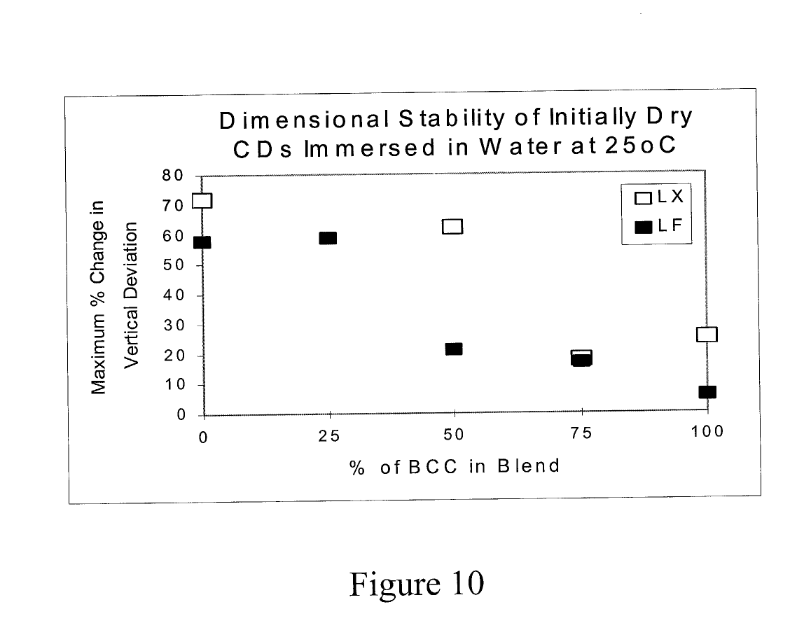

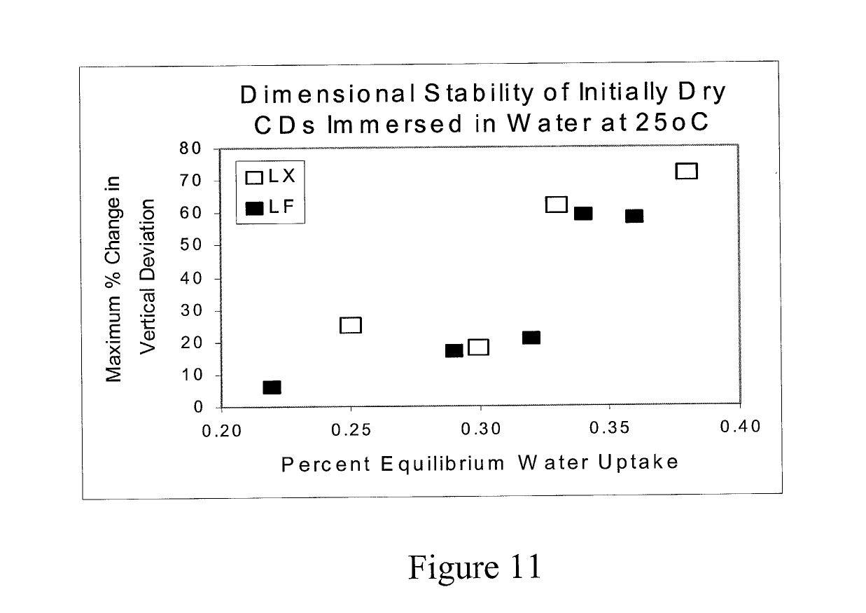

% change in VD=100×(VD at any time−VD at time 0)/VD at time 0. As indicated in Table 4, the maximum percent increase in vertical deviation during the water immersion test is 72 and 58 percent for BPA-PC (Examples 49 and 53, respectively) compared to only 25 and 6 percent for BCC-PC (Examples 52 and 57). The maximum percent change in vertical deviation is plotted versus polymer blend composition (% BCC-PC) in FIG. 10. There is a clear trend towards improved dimensional stability (lower maximum change in vertical deviation) as the percentage of BCC-PC in the blend is increased. Finally, FIG. 11 indicates that a strong correlation exists between dimensional stability (change in vertical deviation) to equilibrium water uptake. This correlation suggests that BCC copolymers and blends, as well as the other compositions of the present invention with reduced equilibrium water uptake will have improved dimensional stability performance as compared to BPA-PC.

Particularly preferred ortho substituted dihydric compounds include the following.

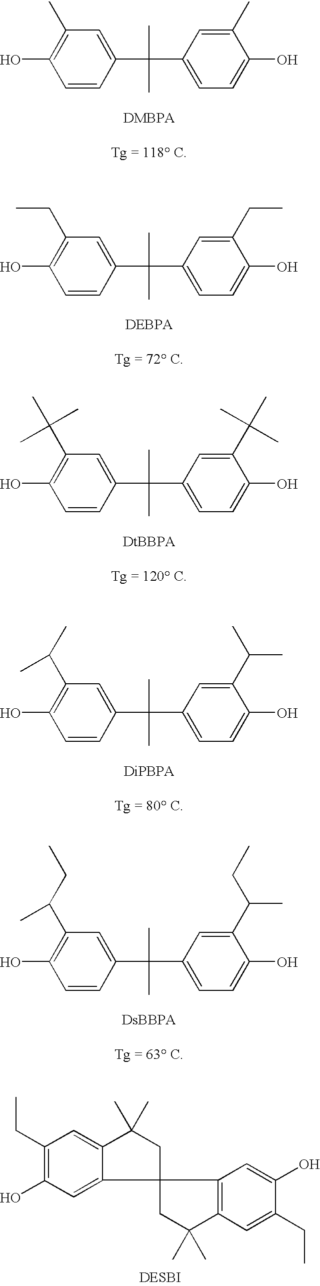

This invention has been described in detail with particular reference to preferred embodiments thereof, but it will be understood that variations and modifications can be effected within the spirit and scope of the invention.

We claim:

1. A polycarbonate comprising
(a) about 99.9 to 0.1 mole percent of carbonate structural units corresponding to 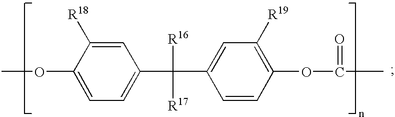
wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁵ and R¹⁹ and are independently selected from C₁-C₆ alkyl, C₃-C₈ cycloalkyl, or phenyl
(b) about 0.1 to 99.9 mole percent of carbonate structural units corresponding to 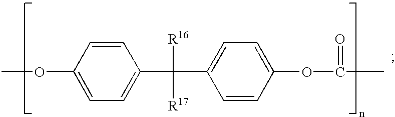
and optionally
(c) further comprising one or more carbonate structural units corresponding to units selected from the group consisting of
(i) 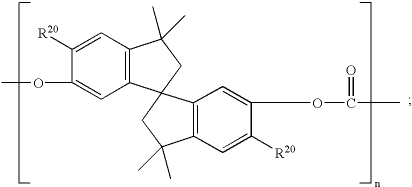
wherein each R²⁰ is independently selected from a group consisting of a C₁-C₆ alkyl, C₃-C₆ cycloalkyl, or phenyl; and
(ii) 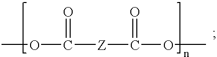
wherein Z is a C₁-C₄₀ branched or straight chain alkyl group or a C₃-C₈ cycloalkyl group group, and n denotes the number of said structural units;
wherein the polycarbonate has a glass transition temperature of from about 100° C. to about 185° C. and a water absorption of below about 0.33%, the total of (a), (b), and (c) being 100 mole percent.

2. The polycarbonate of claim 1, R¹⁸ and R¹⁹ are independently selected from the group consisting of phenyl, methyl, ethyl, isopropyl, n-butyl, t-butyl, and sec-butyl.

3. The polycarbonate of claim 1, wherein R¹⁶ and R¹⁷ are each methyl.

4. The polycarbonate of claim 3, wherein R¹⁸ and R¹⁹ are independently selected from the group consisting of phenyl, methyl, ethyl, isopropyl, n-butyl, t-butyl, and sec-butyl.

5. The polycarbonate of claim 1, wherein R¹⁸ and R¹⁹ are each methyl.

6. The polycarbonate of claim 1, wherein R¹⁸ and R¹⁹ are each sec-butyl.

7. The polycarbonate of claim 1, wherein the glass transition temperature is 120° C. to
165° C.

8. The polycarbonate of claim 1, wherein the water absorption is less than 0.25%.

9. The polycarbonate of claim 7, wherein R¹⁸ and R¹⁹ are each sec-butyl, and wherein R¹⁶ and R¹⁷ are each methyl.

10. A polycarbonate comprising:
(a) about 0.1 to 99.1 mole percent of carbonate structural units corresponding to 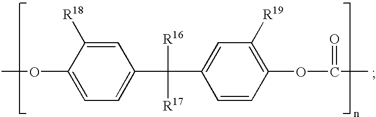
wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸ and R¹⁹ and are independently selected from C₁-C₆ alkyl, C₃-C₈ cycloalkyl, or phenyl
(b) about 99.1 to 0. 1 mole percent of structural units corresponding to 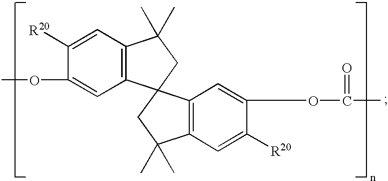
wherein each R²⁰ is independently selected from a group consisting of a C₁-C₆ alkyl, C₃-C₆ cycloalkyl, or phenyl;
wherein the polycarbonate has a glass transition temperature of from about 120° C. to about 185° C. and a water absorption of below about 0.33%.

11. The polyarbonate of claim 10, wherein R¹⁶ and R¹⁷ are each methyl.

12. The polycarbonate of claim 10, wherein R¹⁸ and R¹⁹ are independently selected from the group consisting of phenyl, methyl, ethyl, isopropyl, n-butyl, t-butyl, and sec-butyl.

13. The polycarbonate of claim 11, wherein R¹⁸ and R¹⁹ are independently selected from the group consisting of methyl, ethyl, isopropyl, n-butyl, t-butyl, and sec-butyl.

14. The polycarbonate of claim 10, wherein R¹⁸ and R¹⁹ are each methyl.

15. The polycarbonate of claim 10, wherein R¹⁸ and R¹⁹ are each sec-butyl.

16. The polycarbonate of claim 10, wherein the glass transition temperature is 120° C. to 165° C.

17. The polycarbonate of claim 10, wherein the water absorption is less than 0.25%.

18. The polycarbonate of claim 16, wherein R¹⁸ and R¹⁹ are each sec-butyl, and wherein R¹⁶ and R¹⁷ are each methyl.

19. The polycarbonate of claim 10, wherein each R²⁰ is independently selected from the group consisting of methyl, ethyl, n-propyl, isopropyl, n-butyl, t-butyl, and sec-butyl.

20. An optical article comprising
(I) from 90 to 99.99 percent by weight of a polycarbonate comprising
(a) about 99.9 to 0.1 mole percent of carbonate structural units corresponding to 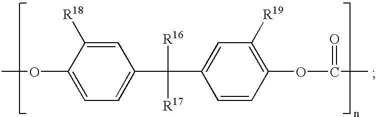
wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸ and R¹⁹ and are independently selected from C₁-C₆ alkyl, C₃-C₈ cycloalkyl, or phenyl
(b) about 0.1 to 99.9 mole percent of carbonate structural units corresponding to 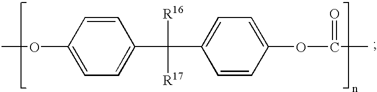
and optionally
(c) further comprising one or more carbonate structural units corresponding to units selected from the group consisting of
(i) 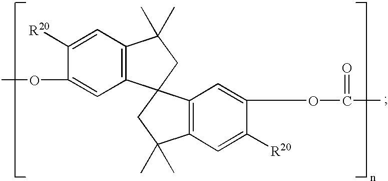
wherein each R²⁰ is independently selected from a group consisting of a C₁-C₆ alkyl, C₃-C₆ cycloalkyl, or phenyl; and
(ii) 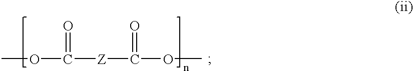
wherein Z is a C₁-C₄₀ branched or straight chain alkyl group or a C₃-C₈ cycloalkyl group group, and n denotes the number of said structural units;
wherein the polycarbonate has a glass transition temperature of from about 120° C. to about 185° C. and a water absorption of below about 0.33%; the total of (a), (b), and (c) being 100 mole percent, and
(II) from 0.01 to 10 weight percent of further additives.

21. The optical article of claim 20, wherein R¹⁶ and R¹⁷ are each methyl.

22. The optical article of claim 20, wherein R¹⁸ and R¹⁹ are independently selected from the group consisting of phenyl, methyl, ethyl, isopropyl, n-butyl, t-butyl, and sec-butyl.

23. The optical article of claim 21, wherein R¹⁸ and R¹⁹ are independently selected from the group consisting of phenyl, methyl, ethyl, isopropyl, n-butyl, t-butyl, and sec-butyl.

24. The optical article of claim 20, wherein R¹⁸ and R¹⁹ are each methyl.

25. The optical article of claim 20, wherein R¹⁸ and R¹⁹ are each sec-butyl.

26. The optical article of claim 20, wherein the glass transition temperature is 130° C. to 150° C.

27. The optical article of claim 20, wherein the water absorption is less than 0.25%.

28. The optical article of claim 26, wherein R¹⁸ and R¹⁹ are each sec-butyl, and wherein R¹⁶ and R¹⁷ are each methyl.

29. The optical article of claim 10, wherein each R²⁰ is independently selected from the group consisting of methyl, ethyl, isopropyl, n-butyl, t-butyl, and sec-butyl.

30. An optical article comprising
(I) from 90 to 99.99 percent by weight of a polycarbonate comprising:
(a) about 0.1 to 99.1 mole percent of carbonate structural units corresponding to 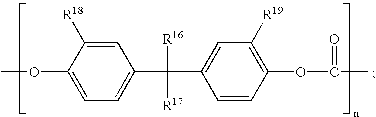
wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸ and R¹⁹ and are independently selected from C₁-C₆ alkyl, C₃-C₈ cycloalkyl, or phenyl
(b) about 99.1 to 0.1 mole percent of structural units corresponding to 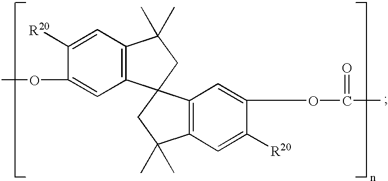
wherein each R²⁰ is independently selected from a group consisting of a C₁-C₆ alkyl, C₃-C₆ cycloalkyl, or phenyl;
wherein the polycarbonate has a glass transition temperature of from about 120° C. to about 185° C. and a water absorption of below about 0.33%; and
(II) from 0.01 to 10 weight percent of further additives.

31. The optical article of claim 30, wherein R¹⁶ and R¹⁷ are each methyl.

32. The optical article of claim 30, wherein R¹⁸ and R¹⁹ are independently selected from the group consisting of phenyl, methyl, ethyl, isopropyl, n-butyl, t-butyl, and sec-butyl.

33. The optical article of claim 31, wherein R¹⁸ and R¹⁹ are independently selected from the group consisting of phenyl, methyl, ethyl, isopropyl, n-butyl, t-butyl, and sec-butyl.

34. The optical article of claim 30, wherein R¹⁸ and R¹⁹ are each methyl.

35. The optical article of claim 30, wherein R¹⁸ and R¹⁹ are each sec-butyl.

36. The optical article of claim 30, wherein the glass transition temperature is 130° C. to 150° C.

37. The optical article of claim 30, wherein the water absorption is less than 0.25%.

38. The optical article of claim 36, wherein R¹⁸ and R¹⁹ are each sec-butyl, and wherein R¹⁶ and R¹⁷ are each methyl.

39. The optical article of claim 30, wherein each R²⁰ is independently selected from the group consisting of methyl, ethyl, isopropyl, t-butyl, and sec-butyl.

40. A miscible polycarbonate blend comprising
(A) a polycarbonate comprising structural units corresponding to 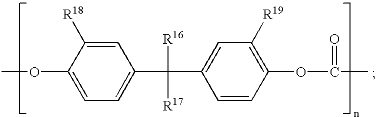
wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸ and R¹⁹ and are independently selected from C₁-C₆ alkyl, C₃-C₈ cycloalkyl, or phenyl
(B) a polycarbonate comprising structural units corresponding to 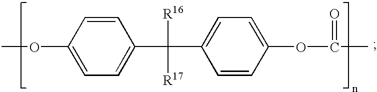
wherein R¹⁶ and R¹⁷ are independently selected from C₁-C₆ alkyl.

41. The blend of claim 40, wherein R¹⁶ and R¹⁷ are each methyl.

42. The blend of claim 40, wherein R¹⁸ and R¹⁹ are independently selected from the group consisting of methyl, ethyl, isopropyl, t-butyl, and sec-butyl.

43. The blend of claim 41, wherein R¹⁸ and R¹⁹ are independently selected from the group consisting of methyl, ethyl, isopropyl, t-butyl, and sec-butyl.

44. The blend of claim 40, wherein R¹⁸ and R¹⁹ are each methyl.

45. The blend of claim 40, wherein R¹⁸ and R¹⁹ are each sec-butyl.

46. The blend of claim 40, wherein the glass transition temperature is 130° C. to 150° C.

47. The blend of claim 40, wherein the water absorption is less than 0.25%.

48. The blend of claim 46, wherein R¹⁸ and R¹⁹ are each sec-butyl, and wherein R¹⁶ and R¹⁷ are each methyl.

49. The blend of claim 40, wherein each R²⁰ is independently selected from the group consisting of methyl, ethyl, isopropyl, t-butyl, and sec-butyl.

50. An optical article comprising
(I) from 90 to 99.99 percent by weight of a miscible polycarbonate blend comprising
(A) a polycarbonate comprising structural units corresponding to 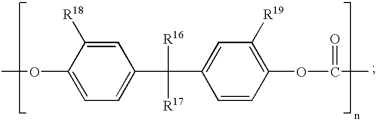
wherein R¹⁶ and R¹⁷ are independently selected from hydrogen, C₁-C₆ alkyl, or phenyl, or R¹⁶ and R¹⁷ are taken together to form a C₃-C₈ cycloalkyl; R¹⁸ and R¹⁹ and are independently selected from C₁-C₆ alkyl, C₃-C₈ cycloalkyl, or phenyl
(B) a polycarbonate comprising structural units corresponding to 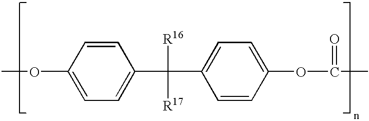
wherein R¹⁶ and R¹⁷ are independently selected from C₁-C₆ alkyl;
wherein the polycarbonate has a glass transition temperature of from about 120° C. to about 185° C. and a water absorption of below about 0.33%; and
(II) from 0.01 to 10 weight percent of further additives.

51. The optical article of claim 50, wherein R¹⁶ and R¹⁷ are each methyl.

52. The optical article of claim 50, wherein R¹⁸ and R¹⁹ are independently selected from the group consisting of phenyl, methyl, ethyl, isopropyl, n-butyl, t-butyl, and sec-butyl.

53. The optical article of claim 51, wherein R¹⁸ and R¹⁹ are independently selected from the group consisting of methyl, ethyl, isopropyl, t-butyl, and sec-butyl.

54. The optical article of claim 50, wherein R¹⁸ and R¹⁹ are each methyl.

55. The optical article of claim 50, wherein R¹⁸ and R¹⁹ are each sec-butyl.

56. The optical article of claim 50, wherein the glass transition temperature is 130° C. to 150° C.

57. The optical article of claim 50, wherein the water absorption is less than 0.25%.

58. The optical article of claim 56, wherein R¹⁸ and R¹⁹ are each sec-butyl, and wherein R¹⁶ and R¹⁷ are each methyl.

59. The optical article of claim 50, wherein each R²⁰ is independently selected from the group consisting of methyl, ethyl, isopropyl, n-butyl, t-butyl, and sec-butyl.
